(19) United States
(12) Patent Application Publication
(10) Pub. No.: US 2024/0240850 A1
(43) Pub. Date: Jul. 18, 2024

(54) REFRIGERATOR

(71) Applicant: SAMSUNG ELECTRONICS CO., LTD., Suwon-si (KR)

(72) Inventors: Inyong HWANG, Suwon-si (KR); Sungjun CHO, Suwon-si (KR)

(73) Assignee: SAMSUNG ELECTRONICS CO., LTD., Suwon-si (KR)

(21) Appl. No.: 18/386,834

(22) Filed: Nov. 3, 2023

Related U.S. Application Data
(63) Continuation of application No. PCT/KR2023/015460, filed on Oct. 6, 2023.

(30) Foreign Application Priority Data
Jan. 13, 2023 (KR) 10-2023-0005328

(51) Int. Cl. F25D 23/12; F25D 23/02

(52) U.S. Cl. CPC F25D 23/126; F25D 23/028

(57) ABSTRACT

A refrigerator including a main body forming a storage room; a door to open and close the storage room; a hinge supporting the door so that the door is rotatable with respect to the main body between an open position and a closed position; a supply line including a water supply hose, wherein the supply line has one end connected to the main body and another end connected to the door, and a first portion of the supply line is movable when the door is rotated; a guide cover on an upper surface of the main body and forming an accommodating space in which the first portion of the supply line is movably accommodated; and a fixing cover on the upper surface of the main body and fixing a second portion of the supply line so that the second portion is maintained in a fixed position.

### TECHNICAL FIELD

The disclosure relates to a refrigerator.

### BACKGROUND ART

A refrigerator is equipment for keeping food fresh by including a main body having a storage room and a cool air supply system for supplying cool air to the storage room. The storage room includes a refrigerating room that is maintained at about 0° C. to 5° C. to keep food refrigerated and a freezing room that is maintained at about 0° C. to 30° C. below zero to keep food frozen. Generally, the front side of the storage room opens to put food therein or take food out, and the open front side of the storage room is opened and closed by a door.

The refrigerator repeatedly performs a cooling cycle which a refrigerant is compressed, condensed, expanded and evaporated by using a compressor, a condenser, an expander, and an evaporator. At this time, both the freezing room and the refrigerating room may be cooled by a single evaporator included in the freezing room, or the freezing room and the refrigerating room may be cooled independently by including separate evaporators.

In a door of the refrigerator, a water supply device, an electrical device (for example, a display), etc. may be provided. Accordingly, the door may need to receive water, power, etc. from the main body.

### DISCLOSURE

### Technical Problem

An aspect of the disclosure provides a refrigerator with an improved structure to supply water or power to a component of the refrigerator, installed in a door.

An aspect of the disclosure provides a refrigerator with an improved structure to guide a position of a supply line.

An aspect of the disclosure provides a refrigerator with an improved structure to guide a movement of a supply line while a door supported by a multi-joint hinge opens and closes a storage room.

An aspect of the disclosure provides a refrigerator with an improved structure to prevent a supply line from being damaged.

An aspect of the disclosure provides a refrigerator with an improved structure to reduce noise generated while water is supplied through a water supply hose.

An aspect of the disclosure provides a refrigerator with an improved structure to uniformly distribute a foaming agent while the foaming agent is injected to foam an insulation between an inner case and an outer case.

An aspect of the disclosure provides a refrigerator with an improved structure to improve convenience of mold making and reduce waste of components.

Technical problems to be achieved by the present document are not limited to the above-mentioned technical problems, and other technical problems not mentioned will be clearly understood by those skilled in the technical art to which the disclosure belongs from the following description.

### Technical Solution

A refrigerator according to an example of the disclosure may include: a main body forming a storage room; a door configured to open and close the storage room; a hinge supporting the door so that the door is rotatable with respect to the main body between an open position in which the storage room is open and a closed position in which the storage room is closed; a supply line including a water supply hose, wherein the supply line has one end connected to the main body and another end connected to the door, and a first portion of the supply line is movable when the door is rotated between the open position and the closed position; a guide cover on an upper surface of the main body and forming an accommodating space in which the first portion of the supply line is movably accommodated; and a fixing cover on the upper surface of the main body and fixing a second portion of the supply line so that the second portion is maintained in a fixed position when the door is rotated between the open and closed position.

A refrigerator according to an example of the disclosure may include: a main body forming a storage room; a door configured to open and close the storage room; a hinge supporting the door such that the door is rotatable with respect to the main body between an open position in which the storage room is open and a closed position in which the storage room is closed; a supply line including a water supply hose and a wire, wherein the supply line has one end connected to the main body and another end connected to the door and a first portion of the supply line is movable when the door is rotated between the open position and the closed position; a guide cover on an outer surface of the main body and forming an accommodating space in which the first portion of the supply line is movably accommodated according rotation of the door between the open position and the closed position; and a fixing cover on the outer surface of the main body and fixing a second portion of the water supply hose between the accommodating space and the outer surface of the main body.

A refrigerator according to an example of the disclosure may include: an outer case; an inner case positioned inside the outer case and forming a storage room; an insulation provided between the outer case and the inner case; a door configured to open and close the storage room; a water tank positioned in the inner case; a water supply positioned in the door; a water supply hose connecting the water tank to the water supply; a line guide provided between the inner case and the outer case and accommodating a first portion of a water supply hose positioned between the inner case and the outer case; a guide cover on an outer surface of the outer case and forming an accommodating space in which a second portion of the water supply hose is movably accommodated; and a fixing cover provided on the outer surface of the outer case and fixing a third portion of the water supply hose between the line guide and the guide cover.

According to an example of the disclosure the fixing cover may include a cover portion that covers the second portion of the supply line, and a fixing portion positioned inside the cover portion and surrounding at least one portion of an outer surface of the second portion of the supply line to maintain the second portion of the supply line in the fixed position.

According to an example of the disclosure the water supply hose may include a first hose portion, a second hose portion, and a connector connecting the first hose portion to the second hose portion. The fixing portion may surround at least one portion of an outer surface of the connector to maintain the connector in the fixed position.

According to an example of the disclosure the fixing portion may space the connector from the main body and may fix the connector to the main body.

According to an example of the disclosure the fixing portion may include a support portion protruding from, and supported by, an inner wall of the cover portion; a first extension portion extending from an end of the support portion opposite to the inner wall of the cover portion, with a surface of the first extension portion facing the inner wall of the cover portion; and a second extension portion extending from an end of the first extension portion opposite to the support portion, with a surface of the second extension portion facing the support portion. The at least a portion of an outer surface of the second portion of the supply line may be covered by each of the support portion, the first extension portion, and the second extension portion.

According to an example of the disclosure the fixing cover may further include a buffer member including an elastic material. The buffer member may be positioned between the at least one portion of the outer surface of the second portion of the supply line and the fixing portion.

According to an example of the disclosure the main body may include an outer case, and an inner case positioned inside the outer case and forming the storage room, and the refrigerator may further comprise a line guide accommodating a third portion of the supply line and positioned between the inner case and the outer case; and a spacer provided between at least one portion of the line guide and the inner case to space the at least one portion of the line guide from the inner case.

According to an example of the disclosure the outer case may include a rear surface, and a side surface. A corner area may be formed between the outer case and the inner case and between the rear surface and side surface of the outer case. The at least one portion of the line guide may be positioned in the corner area.

According to an example of the disclosure the spacer may include at least one pair of spacers, and the at least one portion of the line guide may include a linear portion positioned between the pair of spacers and extending along the corner area close to the outer case.

According to an example of the disclosure the spacer may protrude from the at least one portion of the line guide and may be in contact with the inner case.

According to an example of the disclosure the water supply hose may include a hose bending portion positioned adjacent to the hinge and configured to be bent when the door is rotated from the open position to the closed position, and the water supply hose may further include an elastic spring surrounding an outer circumferential surface of the hose bending portion.

According to an example of the disclosure the supply line may include a line bending portion bent inside the accommodating space of the guide cover, and the guide cover may further include a line support portion supporting the line bending portion when the door is rotated to the open position and the first portion of the supply line moves with respect to the guide cover.

According to an example of the disclosure the guide cover may further include a first penetration opening adjacent to the fixing cover and a second penetration opening adjacent to the hinge. The supply line may penetrate the first penetration opening and the second penetration opening. The line support portion may be positioned behind the first penetration opening, and the line bending portion may be supported by the line support portion behind the line support portion.

According to an example of the disclosure the supply line may further include a wire, one end of the wire may be connected to the main body, and another end of the wire may be connected to the door.

According to an example of the disclosure the refrigerator may further comprise a moving member coupled to the hinge. The moving member may be movable with respect to the guide cover, and may be configured to guide movement of the first portion of the supply line into and out of the accommodating space when the door is rotated between the open position and the closed position.

### DESCRIPTION OF DRAWINGS

FIG. 1 is a perspective view of a refrigerator according to an embodiment of the disclosure;

FIG. 2 schematically shows a water supply flow path of a refrigerator according to an embodiment of the disclosure;

FIG. 3 is a front view separately showing some components of a refrigerator according to an embodiment of the disclosure;

FIG. 4 is a side view separately showing some components of a refrigerator according to an embodiment of the disclosure;

FIG. 5 is a cross-sectional perspective view of a refrigerator according to an embodiment of the disclosure, taken in a horizontal direction;

FIG. 6 is an enlarged view showing some components of a refrigerator according to an embodiment of the disclosure;

FIG. 7 separately shows some components, such as a hinge, a line cover, a line fixing member, a moving member, etc., of a refrigerator according to an embodiment of the disclosure;

FIG. 8 shows a state in which a supply line of a refrigerator according to an embodiment of the disclosure is positioned;

FIG. 9 shows a state in which a supply line of a refrigerator according to an embodiment of the disclosure is positioned;

FIG. 10 is an enlarged view of a structure of a line fixing member for fixing a water supply hose in a refrigerator according to an embodiment of the disclosure;

FIG. 11 is an enlarged view of some components, such as a hinge, a supply line, etc., of a refrigerator according to an embodiment of the disclosure;

FIG. 12 shows a state in which a door is closed in a refrigerator according to an embodiment of the disclosure;

FIG. 13 shows a state of a supply line in a line cover while a door is closed in a refrigerator according to an embodiment of the disclosure;

FIG. 14 shows a state in which a door opens in a refrigerator according to an embodiment of the disclosure;

FIG. 15 shows a state of a supply line in a line cover while a door opens in a refrigerator according to an embodiment of the disclosure;

FIG. 16 is a front view separately showing some components of a refrigerator according to an embodiment of the disclosure;

FIG. 17 is a side view separately showing some components of a refrigerator according to an embodiment of the disclosure; and

FIG. 18 is an enlarged view of some components of a refrigerator according to an embodiment of the disclosure.

### MODES OF THE INVENTION

Various embodiments of the disclosure and terms used therein are not intended to limit the technical features described in the disclosure to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In the disclosure, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of a plurality of associated listed components.

Terms such as “first”, “second”, or “first” or “second” may be used simply to distinguish a component from other components, without limiting the component in other aspects (e.g., importance or order).

Also, the terms “front surface”, “rear surface”, “upper surface”, “lower surface”, “side surface”, “left”, “right”, “upper”, “lower”, etc. used in the disclosure are defined based on the drawings, and the shapes and positions of the corresponding components are not limited by the terms.

It will be understood that when the terms “includes,” “comprises,” “including,” and/or “comprising,” when used in the disclosure, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A refrigerator according to an embodiment may include a main body.

The “main body” may include an inner case, an outer case positioned outside the inner case, and an insulation provided between the inner case and the outer case.

The “inner case” may include at least one of a case, a plate, a panel or a liner forming a storage room. The inner case may be formed as one body, or may be formed by assembling a plurality of plates together. The “outer case” may form an outer appearance of the main body, and may be coupled to an outer side of the inner case to position the insulation between the inner case and the outer case.

The “insulation” may insulate inside of the storage room from outside of the storage room such that internal temperature of the storage room is maintained at preset optimal temperature without being influenced by an external environment of the storage room. According to an embodiment of the disclosure, the insulation may include a foaming insulation. The foaming insulation may be molded by injecting urethane foam as a mixture of polyurethane and a foaming agent between the inner case and the outer case and foaming the urethane foam.

According to an embodiment of the disclosure, the insulation may further include a vacuum insulation, in addition to a foaming insulation, or the insulation may be configured only with a vacuum insulation, instead of a foaming insulation. The vacuum insulation may include a core material, and a cladding material accommodating the core material therein and sealing inside with vacuum or pressure close to vacuum. However, the insulation is not limited to a foaming insulation or a vacuum insulation mentioned above, and may include various materials capable of being used for insulation.

The “storage room” may include a space defined by the inner case. The storage room may further include an inner case defining a space corresponding to a storage room. Various goods, such as food, medicine, cosmetics, etc., may be stored in the storage room, and the storage room may open at at least one side to put the goods in or take the goods out.

The refrigerator may include one or more storage rooms. Two or more storage rooms formed in the refrigerator may have different purposes of use and may be maintained at different temperature. For this, the storage rooms may be partitioned from each other by a partition wall including an insulation.

The storage rooms may be maintained within optimal temperature ranges according to the purposes of use, and may include a “refrigerating room”, a “freezing room”, or a “temperature conversion room” that are divided according to the purposes of use and/or the temperature ranges. The refrigerating room may be maintained at a temperature suitable for keeping goods refrigerated and the freezing room may be maintained at a temperature suitable for keeping goods frozen. The “refrigerating” may mean cooling goods in a range in which the goods are not frozen, and for example, the refrigerating room may be maintained within a range of 0° C. to 7° C. above zero. The “freezing” may mean freezing goods or cooling goods to keep the goods frozen, and for example, the freezing room may be maintained in a range of 1° C. to 20° C. below zero. The temperature conversion room may be used as any one of a refrigerating room or a freezing room according to a user's selection or regardless of a user's selection.

The storage room may be also called various other terms, such as “vegetable room”, “freshness room”, “cooling room”, and “ice-making room”, in addition to “refrigerating room”, “freezing room”, and “temperature conversion room”, and the terms, such as “refrigerating room”, “freezing room”, “temperature conversion room”, etc., as used below need to be understood to represent storage rooms having the corresponding purposes of use and the corresponding temperature ranges.

According to an embodiment of the disclosure, the refrigerator may include at least one door configured to open or close an open side of the storage room. A plurality of doors may be provided to open or close one or more storage rooms independently or a single door may be provided to open or close a plurality of storage rooms. The door may be rotatably or slidably mounted on a front surface of the main body.

The “door” may seal the storage room in a closed state. The door may include an insulation, like the main body, to insulate the storage room in the closed state.

According to an embodiment of the disclosure, the door may include a door outer plate forming a front surface of the door, a door inner plate forming a rear surface of the door and facing the storage room, an upper cap, a lower cap, and a door insulation provided thereinside.

On edges of the door inner plate, a gasket that is tightly pressed against the front surface of the main body upon closing of the door to seal up the storage room may be provided. The door inner plate may include a shelf protruding in a rear direction to install a door basket for storing goods thereon.

According to an embodiment of the disclosure, the door may include a door body, and a front panel detachably coupled to a front side of the door body and forming a front surface of the door. The door body may include a door outer plate forming a front surface of the door body, a door inner plate forming a rear surface of the door body and facing the storage room, a upper cap, a lower cap, and a door insulation provided thereinside.

Refrigerators may be classified into a French Door Type, a Side-by-Side type, a Bottom Mounted Freezer, a Top Mounted Freezer, a one-door refrigerator, etc., according to positions of doors and storage rooms.

According to an embodiment of the disclosure, the refrigerator may include a cool air supply for supplying cool air to the storage room.

The “cool air supply” may be a machine, an apparatus, an electronic device, and/or a combination system thereof, capable of generating cool air and guiding the cool air to cool the storage room.

According to an embodiment of the disclosure, the cool air supply may generate cool air through a cooling cycle including compression, condensation, expansion, and evaporation processes of refrigerants. For this, the cool air supply may include a cooling cycle device having a compressor, a condenser, an expander, and an evaporator to drive the cooling cycle. According to an embodiment of the disclosure, the cool air supply may include a semiconductor such as a thermoelectric element. The thermoelectric element may cool the storage room by heating and cooling actions through the Peltier effect.

According to an embodiment of the disclosure, the refrigerator may include a machine room where at least some components belonging to the cool air supply are installed.

The “machine room” may be partitioned and insulated from the storage room to prevent heat generated from the components installed in the machine room from being transferred to the storage room. To dissipate heat from the components installed inside the machine room, the machine room may communicate with outside of the main body.

According to an embodiment of the disclosure, the refrigerator may include a dispenser installed in the door to provide water and/or ice. The dispenser may be installed in the door to allow a user to access the dispenser without opening the door.

According to an embodiment of the disclosure, the refrigerator may include an ice maker for forming ice. The ice maker may include an ice making tray storing water, an ice transfer device for separating ice from the ice making tray, and an ice bucket storing ice formed in the ice making tray.

According to an embodiment of the disclosure, the refrigerator may include a controller for controlling the refrigerator.

The “controller” may include a memory for storing and/or memorizing data and/or programs for controlling the refrigerator, and a processor for outputting control signals for controlling the cool air supplier, etc. according to the programs and/or data memorized in the memory.

The memory may store or record various information, data, instructions, programs, etc. required for operations of the refrigerator. The memory may memorize temporary data generated while a control signal for controlling components included in the refrigerator is generated. The memory may include at least one of a volatile memory or a non-volatile memory, or a combination of a volatile memory and a non-volatile memory.

The processor may control overall operations of the refrigerator. The processor may execute a program stored in the memory to control components of the refrigerator. The processor may include a neural network processing unit (NPU) that performs operations of an artificial intelligence model. Also, the processor may include a central processing unit (CPU), a graphic processor unit (GPU), and the like. The processor may generate a control signal for controlling operations of the cool air supply. For example, the processor may receive temperature information about temperature of the storage room from a temperature sensor and generate a cooling control signal for controlling operations of the cool air supply based on the temperature information of the storage room.

Also, the processor may process a user input received through a user interface and control operations of the user interface according to the programs and/or data stored/memorized in the memory. The user interface may be provided by using an input interface and an output interface. The processor may receive a user input from the user interface. Also, the processor may transfer a display control signal and image data for displaying an image on the user interface to the user interface in response to the user input.

The processor and the memory may be provided integrally or separately. The processor may include one or more processors. For example, the processor may include a main processor and at least one sub processor. The memory may include one or more memories.

According to an embodiment of the disclosure, the refrigerator may include a processor and a memory for controlling all components included in the refrigerator, and may include a plurality of processors and a plurality of memories for individually controlling the components of the refrigerator. For example, the refrigerator may include a processor and a memory that control operations of the cool air supply according to an output from the temperature sensor. In addition, the refrigerator may include a processor and a memory that control operations of the user interface according to a user input.

A communication module may communicate with an external device, such as a server, a mobile device, or other home appliances, through an access point (AP) around the communication module. The AP may connect a local area network (LAN) to which the refrigerator or a user device is connected to a wide area network (WAN) to which a server is connected. The refrigerator or the user device may be connected to the server through the WAN.

The input interface may include a key, a touch screen, a microphone, and the like. The input interface may receive a user input and transfer the user input to the processor.

The output interface may include a display, a speaker, and the like. The output interface may output various notifications, messages, information, etc. generated by the processor.

Hereinafter, an embodiment of the disclosure will be described in detail with reference to the accompanying drawings.

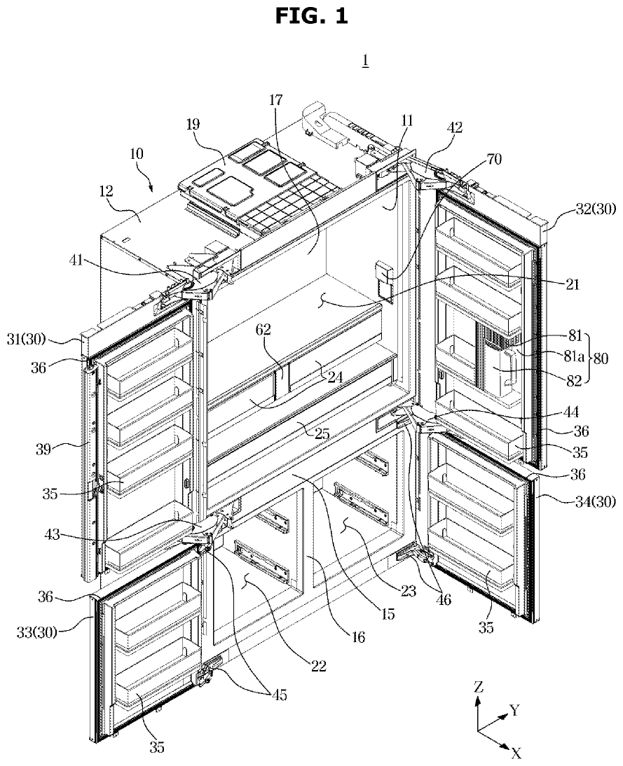

FIG. 1 is a perspective view of a refrigerator according to an embodiment of the disclosure.

Referring to FIG. 1, a refrigerator 1 according to an embodiment of the disclosure may include a main body 10, storage rooms 21, 22, and 23 provided inside the main body 10, a door 30 for opening or closing the storage rooms 21, 22, and 23, and a cooling system for supplying cool air to the storage rooms 21, 22, and 23.

The main body 10 may include an inner case 11 forming the storage rooms 21, 22, and 23, an outer case 12 forming an outer appearance of the refrigerator 1, and a main body insulation 13 provided between the inner case 11 and the outer case 12.

The outer case 12 may be substantially in a shape of a box of which a front side opens. The outer case 12 may form upper and lower surfaces, left and right surfaces, and a rear surface of the refrigerator 1.

More specifically, the outer case 12 may include an upper surface 12a, a lower surface 12b, a rear surface 12c, and side surfaces 12d. The side surfaces 12d may connect the upper surface 12a to the lower surface 12b. The side surfaces 12d may be a pair of side surfaces facing each other.

Under an assumption that a direction of the refrigerator 1, which is orthogonal to up-down and front-rear directions of the refrigerator 1, is a side direction (a Y direction in the drawing) of the refrigerator 1, one of the pair of side surfaces 12d may form a left side (a side located to the left in the drawing) of the main body 10, and another one of the pair of side surfaces 12d may form a right side (a side located to the right in the drawing) of the main body 10.

At least some of the upper surface 12a, the lower surface 12b, the rear surface 12c, and the pair of side surfaces 12d of the outer case 12 may be integrated into one body. For example, the upper surface 12a and the pair of side surfaces 12d may be integrated into one body.

The outer case 12 may include a metal material. For example, the outer case 12 may be manufactured by processing a steel plate material, although not limited thereto.

However, the outer case 12 may be configured variously.

The inner case 11 may open at the front side. The storage rooms 21, 22, and 23 may be formed inside the inner case 11, and the inner case 11 may be provided inside the outer case 12. Inner walls of the inner case 11 may form inner walls of the storage rooms 21, 22, and 23.

The inner case 11 may include a plastic material. For example, the inner case 11 may be manufactured by a vacuum forming process. For example, the inner case 11 may be manufactured by an injection molding process.

The main body insulation 13 may insulate the inner case 11 from the outer case 12. The main body insulation 13 may be foamed between the inner case 11 and the outer case 12 to couple the inner case 11 to the outer case 12. The main body insulation 13 may prevent heat-exchange between insides of the storage rooms 21, 22, and 23 and the outside of the main body 10 to improve cooling efficiency of the storage rooms 21, 22, and 23.

The main body insulation 13 may be a urethane foam insulation, an expanded polystyrene (EPS) insulation, a vacuum insulation panel, etc., although not limited thereto. However, the main body insulation 13 may include various materials.

The storage rooms 21, 22, and 23 may be formed inside the main body 10. For example, the storage rooms 21, 22, and 23 may include a refrigerating room that is maintained at about 0° C. to 5° C. to keep food refrigerated. For example, the storage rooms 21, 22, and 23 may include a freezing room that is maintained at about 0° C. to 30° C. below zero to keep food frozen.

The storage rooms 21, 22, and 23 may be partitioned into a plurality of storage rooms by a horizontal partition wall 15 and a vertical partition wall 16. The storage rooms 21, 22, and 23 may be partitioned into an upper storage room 21 and lower storage rooms 22 and 23 by the horizontal partition wall 15, and the lower storage rooms 22 and 23 may be partitioned into a left lower storage room 22 and a right lower storage room 23 by the vertical partition wall 16.

For example, the upper storage room 21 may be used as a refrigerating room, and the lower storage rooms 22 and 23 may be used as freezing rooms. However, the above-described partitioning and purposes of use of the storage rooms 21, 22, and 23 are only examples, and the disclosure is not limited thereto.

Inside the storage rooms 21, 22, and 23, a shelf (not shown) on which food is put and storage containers 24 and 25 for keeping food may be provided.

The refrigerator 1 may include a cooling system for generating cool air by using a cooling cycle and supplying the generated cool air to the storage rooms 21, 22, and 23. The cooling system may generate cool air by using a cooling circulation cycle of compressing, condensing, expanding, and evaporating refrigerants. For example, the cooling system may include a compressor, a condenser, an expansion valve, an evaporator, and a blowing fan.

The main body 10 may include a cool air supply duct 17. The cool air supply duct 17 may form a flow path of cool air through which cool air generated by the cooling system flows to the storage rooms 21, 22, and 23. The storage rooms 21, 22, and 23 may communicate with the cool air supply duct 17.

The cool air supply duct 17 may be formed inside the inner case 11. The cool air supply duct 17 may be formed at a rear portion of the inner case 11. More specifically, the cool air supply duct 17 may be provided at rear portions of the storage rooms 21, 22, and 23.

The door 30 may open or close the storage rooms 21, 22 and 23. The door 30 may be rotatable with respect to the main body 10. More specifically, the door 30 may be rotatably coupled to the main body 10 by hinges 41, 42, 43, 44, 45, and 46 respectively connected to the door 30 and the main body 10.

An outer surface of the door 30 may form a portion of an outer appearance of the refrigerator 1. While the door 30 is at a closed position, an outer surface of the door 30 may form a front surface of the door 30.

While the door 30 is at the closed position, an inner surface of the door 30 may form a rear surface of the door 30. While the door 30 is at the closed position, the inner surface of the door 30 may face the inside of the main body 10. While the door 30 is at the closed position, the inner surface of the door 30 may cover front sides of the storage rooms 21, 22, and 23.

A foaming space may be formed between the outer surface of the door 30 and the inner surface of the door 30, and a door insulation (not shown) may be foamed into the foaming space. The door insulation may prevent heat-exchange between the outer surface of the door 30 and the inner surface of the door 30. The door insulation may improve heat insulation performance between the insides of the storage rooms 21, 22, and 23 and the outside of the door 30.

The door insulation may be a urethane foam insulation, an EPS insulation, a vacuum insulation panel, etc., although not limited thereto. However, the door insulation may include various materials.

For example, the door insulation may be made of the same material as the main body insulator 13. Alternatively, for example, the door insulation may be made of a different material from the main body insulation 13.

A door gasket 36 may be provided on the inner surface of the door 30 to seal a gap between the door 30 and the main body 10, thereby preventing leakage of cool air in the storage rooms 21, 22, and 23. The door gasket 36 may be positioned along a circumference of the inner surface of the door 30. The door gasket 36 may include an elastic material such as rubber.

On a rear surface of each of a plurality of doors 31, 32, 33, and 34, a door basket 35 for keeping food, and a door gasket 36 that is tightly pressed against the front surface of the main body 10 to seal the corresponding storage room 21, 22, or 23 upon closing of the door 31, 32, 33, or 34 may be provided.

The door 30 may include the plurality of doors 31, 32, 33, and 34 that respectively open or close the storage rooms 21, 22, and 23 partitioned from each other.

For example, the upper storage room 21 may be opened or closed by a pair of upper doors 31 and 32. The pair of upper doors 31 and 32 may be rotatably coupled to the main body 10. The left lower storage room 22 may be opened or closed by a left lower door 33, and the left lower door 33 may be rotatably coupled to the main body 10. The right lower storage room 23 may be opened or closed by a right lower door 34, and the right lower door 34 may be rotatably coupled to the main body 10.

Any one door (for example, a left upper door 31) of the pair of upper doors 31 and 32 may include a rotating bar 39 that is rotatable with respect to the door and covers a gap between the pair of upper doors 31 and 32.

The refrigerator 1 may include the hinges 41, 42, 43, 44, 45, and 46 connecting the door 30 to the main body 10. The hinges 41, 42, 43, 44, 45, and 46 may support the door 30 to enable the door 30 to rotate with respect to the main body 10.

The hinges 41, 42, 43, 44, 45, and 46 may be a plurality of hinges for rotatably supporting the plurality of doors 31, 32, 33, and 34, respectively.

For example, the hinges 41, 42, 43, 44, 45, and 46 may include hinges 41 and 43 supporting the left upper door 31, hinges 42 and 44 supporting the right upper door 32, a hinge 45 supporting the left lower door 33, and a hinge 46 supporting the right lower door 34.

The plurality of hinges 41, 42, 43, 44, 45, and 46 may have the same or similar configurations or shapes. Alternatively, the plurality of hinges 41, 42, 43, 44, 45, and 46 may have different configurations or shapes.

Each of the plurality of hinges 41, 42, 43, 44, 45, and 46 may be a multi-joint hinge including a main body bracket coupled to the main body 10, a door bracket coupled to the door 30, and at least one hinge link connecting the door bracket to the main bracket.

Details about the configurations of the hinges 41, 42, 43, 44, 45, and 46 will be described below.

The refrigerator 1 may include a controller (not shown) configured to control operations of the refrigerator 1. The controller of the refrigerator 1 may be configured with various electronic components, such as at least one printed circuit board assembly (PBA).

For example, the controller of the refrigerator 1 may be configured to control driving of components of the cooling system, such as an evaporator 71, a blowing fan 72, a compressor 73, and a condenser. For example, the controller of the refrigerator 1 may control operations of a dispenser 70 or a water supply assembly 80, which will be described below. Also, for example, in a case in which the refrigerator 1 includes a display (not shown), the controller of the refrigerator 1 may control driving of the display.

The main body 10 of the refrigerator 1 may include an electrical box 19 in which at least some of various electrical components constituting the controller are accommodated. For example, the electrical box 19 may be provided on the upper surface 12a of the outer case 12, although a location of the electrical box 19 is not limited thereto.

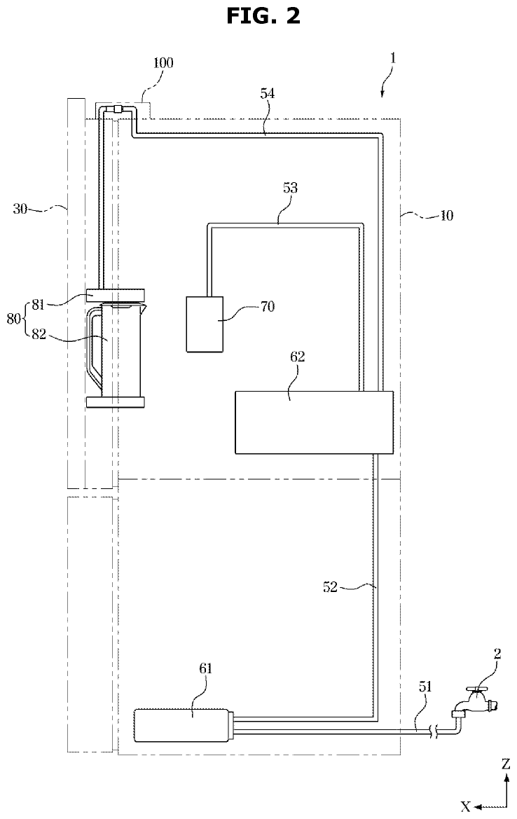

The refrigerator 1 may include a water tank 62 storing water supplied from an external water supply source 2 (see FIG. 2). The water tank 62 may be provided inside the inner case 11. The water tank 62 may be provided in the storage room 21. Water stored in the water tank 62 may be cooled by cool air of the storage room 21, and then supplied to the dispenser 70 or the water supply assembly 80.

For example, a lower portion of the water tank 62 may be supported by the lower storage container 25. For example, the water tank 62 may be positioned between a pair of upper storage containers 24, although not limited thereto. However, the water tank 62 may be supported by various components in the inner case 11.

The refrigerator 1 may include the dispenser 70 and the water supply assembly 80 for providing water to a user. The dispenser 70 and the water supply assembly 80 may receive water from the external water supply source 2 (see FIG. 2).

For example, the dispenser 70 may be provided in the main body 10. For example, the water supply assembly 80 may be provided in the door 30.

The dispenser 70 may supply water while a lever is pressed.

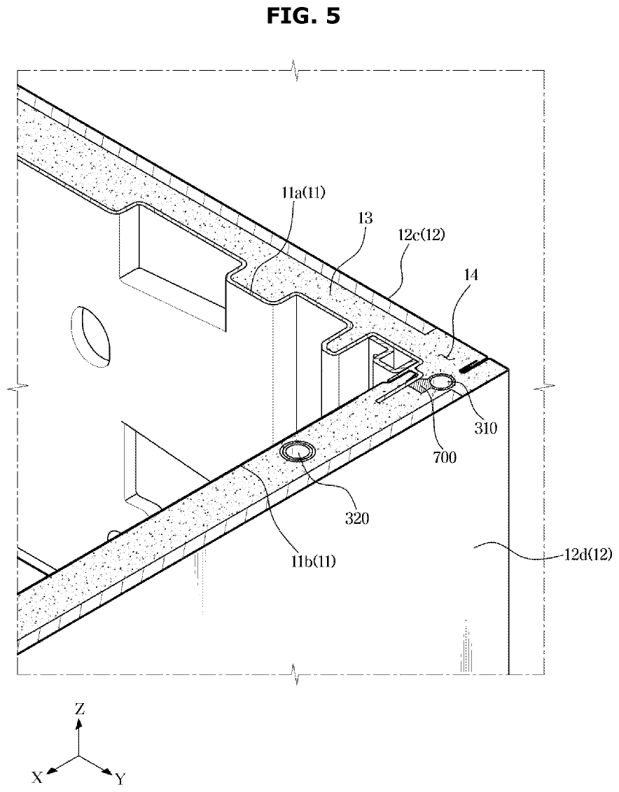

The water supply assembly 80 may include a water supply 81 and a water bucket 82. The water supply 81 may supply water received from the external water supply source 2 (see FIG. 5) to the water bucket 82. The water bucket 82 may store the water supplied from the water supply 81.

The water supply 81 may include a bucket installing space 81a in which the water bucket 82 is installed. The water bucket 82 may be detachably installed in the bucket installing space 81a.

The water supply 81 may include an outlet (not shown) for supplying water to the water bucket 82 installed in the bucket installing space 81a. The water bucket 82 may include an inlet (not shown) which water discharged from the outlet of the water supply 81 enters. For example, the outlet of the water supply 81 may discharge water supplied from the external water supply source 2 downward. For example, the inlet of the water bucket 82 may be formed at an upper portion of the water bucket 82 and penetrate the upper portion of the water bucket 82 in the up-down direction. For example, upon installation of the water bucket 82 in the bucket installing space 81a, the outlet of the water supply 81 may face the inlet of the water bucket 82 in the up-down direction.

The refrigerator 1 may include a bucket sensor (not shown) for detecting installation of the water bucket 82 in the bucket installing space 81a. The bucket sensor may be positioned on the inner surface of the door 30 or the water supply 81. The controller of the refrigerator 1 may identify installation of the water bucket 82 in the bucket installing space 81a based on an output value from the bucket sensor. The controller of the refrigerator 1 may control the water supply 81 to supply water to the water bucket 82 according to identification that the water bucket 82 has been installed in the bucket installing space 81a. For example, the bucket sensor may be a hall sensor that detects a magnet (not shown) provided in the water bucket 82.

According to identification that the water bucket 82 has been installed in the bucket installing space 81a, the water supply 81 may automatically supply water to the water bucket 82 to fill a preset amount of water in the water bucket 82. The preset amount of water may be substantially a full water level of the water bucket 82.

For example, the water supply 81 may include a water level sensor (not shown) for detecting a water level of the water bucket 82 upon installation of the water bucket 82 in the bucket installing space 81a. The water level sensor may output an electrical signal corresponding to the water level of the water bucket 82. The controller of the refrigerator 1 may receive the electrical signal output from the water level sensor and identify an amount of water stored in the water bucket 82 based on the electrical signal. The controller of the refrigerator 1 may control the water supply 81 to stop supplying water to the water bucket 82 according to identification that the amount of water stored in the water bucket 82 is a preset amount of water or more. The controller of the refrigerator 1 may control the water supply 81 to supply water to the water bucket 82 according to identification that the amount of water stored in the water bucket 82 is less than the preset amount of water. For example, the water level sensor may be a capacitive sensor for detecting capacitance changing according to a water level of the water bucket 82.

The water supply 81 may be installed in the door 30. For example, the water supply 81 may be mounted on the inner surface of the door 30. While the door 30 is at the closed state, the water supply 81 may be positioned inside the storage rooms 21, 22, and 23, and the water bucket 82 installed in the bucket installing space 81a may be positioned inside the storage rooms 21, 22, and 23. While the door 30 is at the closed state, the water bucket 82 installed in the bucket installing space 81a may be cooled by cool air of the storage rooms 21, 22, and 23, and accordingly, a user may be provided cold water from the water bucket 82.

Details about a component for enabling the water supply 81 to receive water from the external water supply source 2 will be described below.

However, the above-described configuration of the water supply assembly 80 is only an example for describing a water supply assembly of the refrigerator according to a concept of the disclosure, and a concept of the disclosure is not limited thereto.

The dispenser 70 may be provided at various locations on the inner case 11 of the main body 10, and the water supply assembly 80 may be provided at various locations of the door 30. Hereinafter, as shown in FIG. 1, an embodiment in which the dispenser 70 is provided at a right inner wall of the inner case 11 and the water supply assembly 80 is provided at the right upper door 32 will be described, although a concept of the disclosure is not limited thereto. However, for example, the dispenser 70 may be provided at a left inner wall of the inner case 11. Also, for example, the water supply assembly 80 may be provided at the left upper door 31.

The configuration of the refrigerator 1, as described above with reference to FIG. 1, is only an example for describing a refrigerator according to a concept of the disclosure, and the concept of the disclosure is not limited thereto.

Hereinafter, for convenience of description, the upper right door 32 of the plurality of doors 31, 32, 33, and 34 will be described as an example, and the upper right door 32 will be referred to as a “door 30”, for convenience of description. Characteristics of the “door 30”, which will be described below, may also be applied to the other doors 31, 32, and 33 correspondingly.

Also, hereinafter, for convenience of description, the upper right hinge 42 of the plurality of hinges 41, 42, 43, 44, 45, and 46 will be described as an example, and the upper right hinge 42 will be referred to as a “hinge 100”, for convenience of description. Characteristics of the hinge “100”, which will be described below, may also be applied to the other hinges 41, 43, 44, 45, and 46 correspondingly.

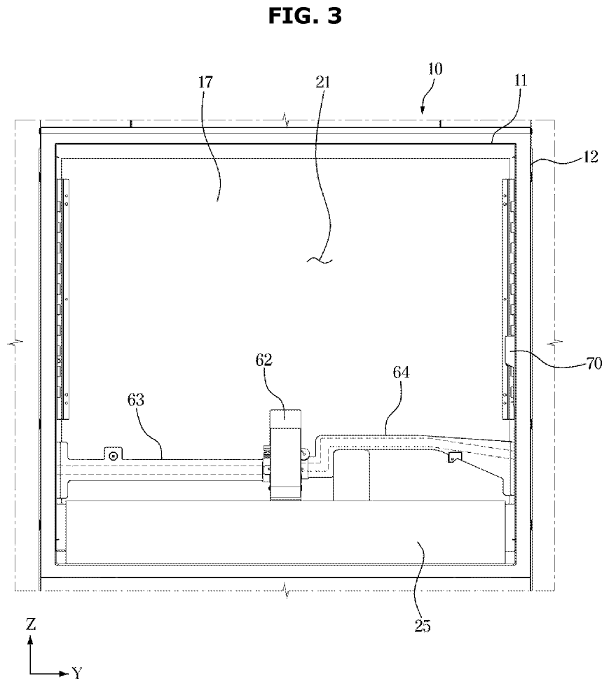

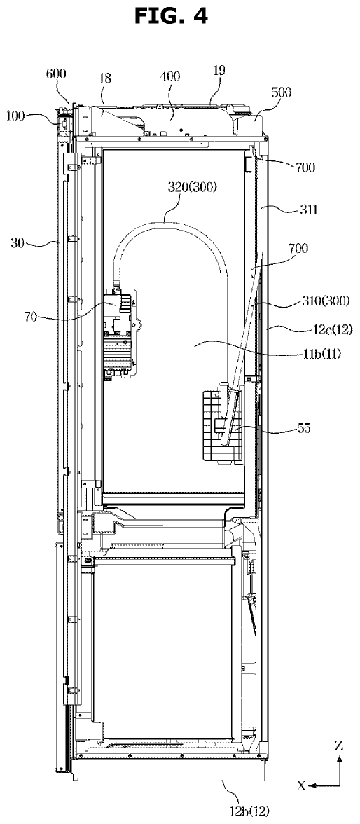

FIG. 2 schematically shows a water supply flow path of a refrigerator according to an embodiment of the disclosure. FIG. 3 is a front view separately showing some components of a refrigerator according to an embodiment of the disclosure. FIG. 4 is a side view separately showing some components of a refrigerator according to an embodiment of the disclosure.

Referring to FIGS. 2 to 4, the refrigerator 1 may provide a user with water received from the external water supply source 2, through the dispenser 70 or the water supply assembly 80.

More specifically, the refrigerator 1 may include a water filter 61, a water tank 62, the dispenser 70, and the water supply assembly 80.

The water filter 61 may purify water supplied from the external water supply source 2. The water filter 61 may purify water supplied through a flow path 51 connected to the external water supply source 2 and transfer the purified water to the water tank 62 through a flow path 52 connected to the water tank 62.

The water tank 62 may store water received from the water filter 61. Water stored in the water tank 62 may be cooled by cool air of the storage room 21.

The dispenser 70 may receive water through a flow path 53 connected to the water tank 62. The flow path 53 connecting the dispenser 70 to the water tank 62 may be formed inside a second water supply duct 64 and a dispenser connecting guide 320 which will be described below.

The water supply assembly 80 may receive water through a flow path 54 connected to the water tank 62. The flow path 54 connecting the water supply assembly 80 to the water tank 62 may be formed by a water supply hose 210 sequentially passing through the second water supply duct 64, a water supply assembly connecting guide 310, a fixing cover 500, a guide cover 400, a moving member 600, the hinge 100, and the door 30, which will be described below.

As shown in FIG. 3, the refrigerator 1 may include water supply ducts 63 and 64 provided in the storage room 21 and connected to the water tank 62. For example, the water supply ducts 63 and 64 may be provided at the rear portion of the inner case 11. The water supply ducts 63 and 64 may be provided in front of the cool air supply duct 17.

The water supply ducts 63 and 64 may include a first water supply duct 63 forming a flow path through which water is supplied to the water tank 62, and the second water supply duct 64 forming a flow path through which water is supplied from the water tank 62.

The flow path 52 extending from the water filter 61 to the water tank 62 may pass through the first water supply duct 63. The flow paths 53 and 54 extending from the water tank 62 toward the dispenser 70 or the water supply assembly 80 may pass through the second water supply duct 64.

As shown in FIGS. 2 and 4, a flow path through which water supplied from the water tank 62 flows may diverge into the flow path 53 toward the dispenser 70 and the flow path 54 toward the water supply assembly 80. The flow path 53 extending from the water tank 62 toward the dispenser 70 and the flow path 54 extending from the water tank 62 toward the water supply assembly 80 may diverge at a flow path diverging portion 55. The second water supply duct 64 may extend from the water tank 62 up to the flow path diverging portion 55.

For example, the water filter 61 may be provided at a left lower portion of the refrigerator 1. In this case, the first water supply duct 63 may extend from a left portion of the storage room 21 up to the water tank 62. The second water supply duct 64 may extend from the water tank 62 up to the flow path diverging portion 55 located at a right portion of the storage room 21.

For example, the water tank 62 may be positioned at a center portion of the storage room 21.

The refrigerator 1 may include a line guide 300. The line guide 300 may accommodate at least one portion of a supply line 200 which will be described below.

The line guide 300 may be positioned between the inner case 11 and the outer case 12. The line guide 300 may be buried in the main body insulation 13 foamed between the inner case 11 and the outer case 12.

As shown in FIG. 4, the line guide 300 may be provided at a right portion of the main body 10. However, a location of the line guide 300 may change depending on locations of the dispenser 70 and the water supply assembly 80, and the location of the line guide 300 is not limited.

The line guide 300 may be in a shape of a hollow pipe.

The line guide 300 may include the water supply assembly connecting guide 310 through which the flow path 54 extending from the water tank 62 toward the water supply assembly 80 passes, and the dispenser connecting guide 320 through which the flow path 53 extending from the water tank 62 toward the dispenser 70 passes.

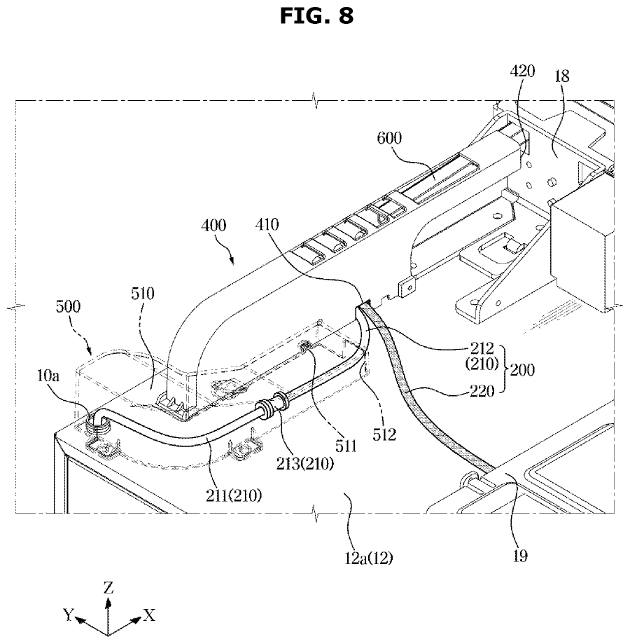

Both the water supply assembly connecting guide 310 and the dispenser connecting guide 320 may be connected to the flow path diverging portion 55. The dispenser connecting guide 320 may be connected to the dispenser 70 coupled to a side surface 11b of the inner case 11. The water supply assembly connecting guide 310 may be connected to a main body penetration portion 10a (see FIG. 8) formed in the upper surface 12a of the main body 10.

One end of the dispenser connecting guide 320 may be connected to the flow path diverging portion 55 provided in the inner case 11, and another end of the dispenser connecting guide 320 may be connected to the dispenser 70 provided in the inner case 11. A portion of the dispenser connecting guide 320 between the one end and the other end may be positioned between the side surface 11b of the inner case 11 and the side surface 12d of the outer case 12. The dispenser connecting guide 320 may be a shape substantially bent from the one end to the other end, although not limited thereto.

One end of the water supply assembly connecting guide 310 may be connected to the flow path diverging portion 55, and another end of the water supply assembly connecting guide 310 may be connected to the main body penetration portion 10a (see FIG. 8). A portion of the water supply assembly connecting guide 310 between the one end to the other end may be positioned adjacent to an inner corner portion of the main body 10. The water supply assembly connecting guide 310 may extend substantially in the up-down direction of the refrigerator 1.

However, flow paths through which water supplied from the external water supply source 2 passes and components of the refrigerator 1 for guiding the flow paths are not limited to the above-described components, and may be configured variously according to locations of the water filter 61, the water tank 62, the dispenser 70, and the water supply assembly 80.

FIG. 5 is a cross-sectional perspective view of a refrigerator according to an embodiment of the disclosure, taken in a horizontal direction.

Hereinafter, in the following description about an embodiment of the disclosure, which will be given with reference to FIG. 5, the water supply assembly connecting guide 310 is referred to as a “line guide 310”, for convenience of description.

Referring to FIG. 5, the refrigerator 1 may include a spacer 700 for spacing the line guide 310 from the inner case 11.

In an operation of manufacturing the refrigerator 1 according to an embodiment of the disclosure, a process of locating the line guide 310 between the inner case 11 and the outer case 12 and then foaming the main body insulation 13 between the inner case 11 and the outer case 12 may be performed. Generally, upon foaming of the main body insulation 13, a foaming agent may be injected into a space between the inner case 11 and a rear portion of the outer case 12, and the foaming agent may spread to fully fill the space between the inner case 11 and the outer case 12.

In this case, because the line guide 310 is positioned in the space between the inner case 11 and the outer case 12, a flow of the foaming agent may be interrupted by the line guide 310. Accordingly, the foaming agent may be not sufficiently uniformly distributed between the inner case 11 and the outer case 12, which leads to a reduction of insulation efficiency of the main body insulation 13. In a case in which at least one portion of the line guide 310 is positioned along the inner corner of the main body 10, as shown in FIG. 5, the problem may become more serious.

To overcome the problem, the spacer 700 may be provided between at least one portion of the guide line 310 and the inner case 11 such that at least one portion of the line guide 310 is spaced from the inner case 11. Due to a space formed between the line guide 310 and the inner case 11 by the spacer 700, foaming efficiency of the insulation may be improved.

The spacer 700 may connect the side surface 11b of the inner case 11 to an outer surface of the line guide 310. The spacer 700 may be supported by the inner case 11 while at least one portion of the line guide 310 is spaced a preset distance from the inner case 11, although not limited thereto.

However, the spacer 700 may connect, for example, the rear surface 12c of the inner case 11 to the outer surface of the line guide 310.

For example, the spacer 700 may protrude from the line guide 300 and be in contact with the inner case 11. More specifically, the spacer 700 may be integrated into the line guide 300, although not limited thereto. However, the spacer 700 may protrude from the inner case 11 to be in contact with the line guide 300, or the spacer 700 may be integrated into the inner case 11.

As shown in FIG. 4, the spacer 700 may include at least a pair of spacers, although a number of the spacer 700 is not limited thereto. However, a single spacer may be provided, or a plurality of spacers of three or more may be provided.

As described above, at least one portion of the line guide 300 may be positioned along the inner corner of the main body 10.

More specifically, the main body 10 may include a corner area 14 forming the inner corner of the main body 10. The corner area 14 may be formed between the inner case 11 and the outer case 12 and between the rear surface 12c and side surface 12d of the outer case 12.

At least one portion of the line guide 310 may be positioned along the corner area 14. The spacer 700 may also be positioned at the corner area 14 or at least adjacent to the corner area 14.

At least one portion of the line guide 310 may be in close contact with the outer case 12 and extend along the corner area 14. Because at least one portion of the line guide 310 is in close contact with the outer case 12, foaming efficiency of the foaming agent at the corner area 14 may be more improved.

More specifically, the line guide 310 may include a linear portion 311 (see FIG. 4). The linear portion 311 may be in close contact with the outer case 12 and extend in one direction along the corner area 14.

The linear portion 311 may extend substantially in the up-down direction along the corner area 14.

The linear portion 311 may be positioned between the pair of spacers 700. The linear portion 311 may be spaced from the inner case 11.

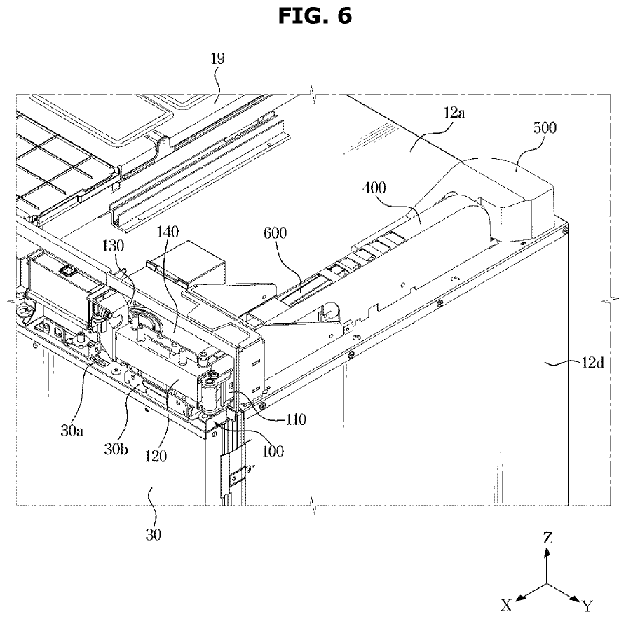

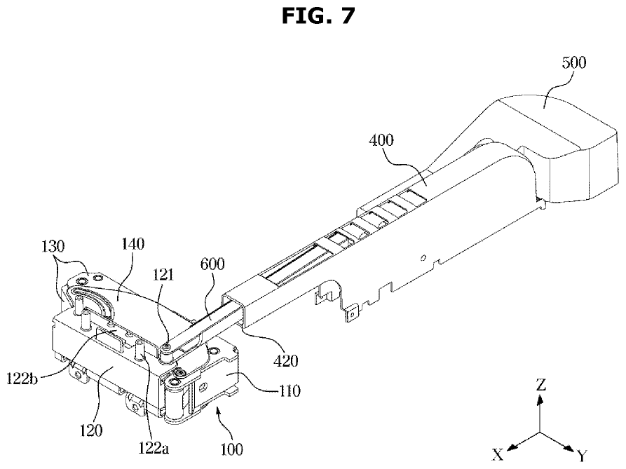

FIG. 6 is an enlarged view showing some components of a refrigerator according to an embodiment of the disclosure. FIG. 7 separately shows some components, such as a hinge, a line cover, a line fixing member, a moving member, etc., of a refrigerator according to an embodiment of the disclosure.

Referring to FIGS. 6 and 7, the hinge 100 connecting the door 30 of the refrigerator 1 to the main body 10 may be a multi-joint hinge.

In a case in which the refrigerator 1 includes a hinge that allows the door 30 to rotate on a single rotation axis with respect to the main body 10, the door 30 opened to a certain angle or more may interfere with an object located adjacent to the refrigerator 1. For example, in a case in which the refrigerator 1 is installed in a built-in type within a cabinet (not shown) or positioned adjacent to other home appliances in a left-right direction, the door 30 may fail to fully open the storage rooms 21, 22, and 23 by interfering with an adjacent object. In this case, a user who tries to take food, etc. out of the storage rooms 21, 22, and 23 of the refrigerator 1 may feel inconvenience.

However, in a case in which the refrigerator 1 is spaced a sufficient distance from adjacent objects such that the door 30 does not interfere with the adjacent objects although the door 30 fully opens the storage rooms 21, 22, and 23, there may be a risk of damaging the overall aesthetics.

To overcome the problem, the hinge 100 of the refrigerator 1 according to an embodiment of the disclosure may include a main body bracket 110 fixed to the main body 10, a door bracket 120 fixed to the door 30, and at least one hinge link 130 connecting the main body bracket 110 to the door bracket 120.

By the configuration of the hinge 100, the door 30 may open the storage rooms 21, 22, and 23 by rotating while moving forward toward the front direction of the refrigerator 1 with respect to the main body 10. In other words, the door 30 may open the storage rooms 21, 22, and 23 by rotating as though the door 30 is drawn toward the front direction of the refrigerator 1 with respect to the main body 10. In this case, the door 30 may be prevented from interfering with an object located adjacent to the refrigerator 1 although the door 30 rotates with respect to the main body 10 to fully open the storage rooms 21, 22, and 23.

The main body 10 may include a hinge fixing bracket 18 supporting the hinge 100. The hinge fixing bracket 18 may fix the main body bracket 110 to the main body 10. The hinge fixing bracket 18 may be coupled to the outer case 12.

The hinge fixing bracket 18 may be fixed to the outer case 12 in various previously known fixing methods. The main body bracket 110 may be fixed to the hinge fixing bracket 18 using various known fixing methods.

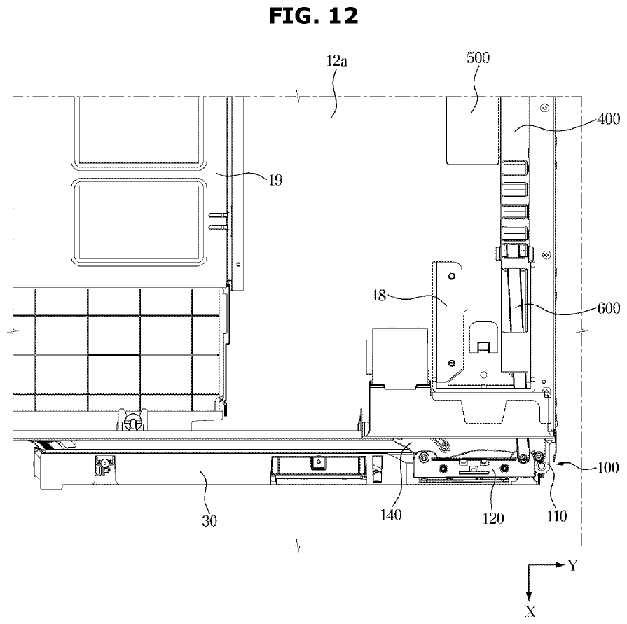

Details about operations of the hinge 100 will be described with reference to FIGS. 12 to 15, below.

The refrigerator 1 may include a supply line 200 (see FIG. 8, etc.) for supplying water or power from the main body 10 toward the door 30. One end of the supply line 200 may be connected to the main body 10. Another end of the supply line 200 may be connected to the door 30.

For example, the supply line 200 may include the water supply hose 210 (see FIG. 8, etc.). The water supply hose 210 may supply water supplied from the external water supply source 2 to the water supply assembly 80 provided in the door 30. More specifically, the water supply hose 210 may supply water supplied from the external water supply source 2 and passed through the water filter 61, the water tank 62, etc. to the water supply assembly 80. The water supply hose 210 may be connected to the water supply 81 of the water supply assembly 80.

Alternatively, although not shown in the drawings, a separate dispenser (not shown) may be provided in the door 30, and the water supply hose 210 may supply water supplied from the external water supply source 2 to the dispenser provided in the door 30.

For example, the supply line 200 may include a wire 220 (see FIG. 8, etc.). The wire 220 may include a conductive wire made of a material having high electrical conductivity, such as copper, and an insulating coating surrounding the conductive wire. The wire 220 may connect the controller (not shown) accommodated in the electrical box 19 to the water supply assembly 80 provided in the door 30. The water supply assembly 80 may receive power through the wire 220. Also, the water supply assembly 80 may receive a control signal transmitted from the controller through the wire 220. The controller may transfer a control signal to the water supply assembly 80 through the wire 220 and receive signals output from various sensors of the water supply assembly 80. Alternatively, although not shown in the drawing, a display (not shown) may be provided on the door 30, and the wire 220 may connect the controller accommodated in the electrical box 19 to the display provided in the door 30.

Although the one end of the supply line 200 is connected to the main body 10 and the other end is connected to the door 30, the door 30 may be not directly coupled to the main body 10 and may be coupled to the main body 10 by the hinge 100, as described above. Also, because the hinge 100 is a multi-joint hinge, a distance between the door 30 and the main body 10 may change upon opening or closing of the door 30. Accordingly, at least one portion of the supply line 200 connected to both the main body 10 and the door 30 may need to be movable according to opening or closing of the door 30.

The refrigerator 1 may include a guide cover 400 accommodating a portion of the supply line 200. The guide cover 400 may cover the portion of the supply line 200. The portion of the supply line 200 may be protected by the guide cover 400.

The guide cover 400 may be provided on the outer surface of the main body 10. More specifically, as shown in FIG. 6, the guide cover 400 may be provided on the upper surface 12a of the main body 10.

The guide cover 400 may form an accommodating space 401 in which the portion of the supply line 200 is movably accommodated. For example, the accommodating space 401 may be defined as a space between an inner surface of the guide cover 400 and an outer surface of the main body 10. The supply line 200 may be movable with respect to the accommodation space 401 according to opening or closing of the door 30.

The guide cover 400 may maintain a fixed position with respect to the main body 10. For example, the guide cover 400 may be hook-coupled to the outer case 12. For example, the guide cover 400 may be screwed to the hinge fixing bracket 18.

The refrigerator 1 may further include the moving member 600 for guiding a portion of the supply line 200 to be drawn into or from the accommodating space 401 according to opening or closing of the door 30. The moving member 600 may have one end coupled to the hinge 100 and another end positioned in the accommodating space 401 of the guide cover 400 to be movable with respect to the accommodating space 401.

The moving member 600 may cover a portion of the supply line 200. The moving member 600 may guide a position of the portion of the supply line 200.

A detailed description about configurations and functions of the guide cover 400 and the moving member 600 will be described below.

Meanwhile, in a case in which a portion of the supply line 200 is movable, a tangle may occur according to movement of the supply line 200 while at least another portion of the supply line 200 is not fixed.

To overcome the problem, the refrigerator 1 may include a fixing cover 500. The fixing cover 500 may fix another portion of the supply line 200.

The fixing cover 500 may cover another portion of the supply line 200. The other portion of the supply line 200 may be protected by the fixing cover 500.

That is, a portion of the supply line 200 may be covered by the guide cover 400, and another portion of the supply line 200 may be covered by the fixing cover 500.

According to a rotation of the door 30 with respect to the main body 10, the portion of the supply line 200, covered by the guide cover 400, may be movable, and the other portion of the supply line 200, covered by the fixing cover 500, may be maintained at a fixed position.

The fixing cover 500 may be provided on the outer surface of the main body 10. More specifically, as shown in FIG. 6, the fixing cover 500 may be provided on the upper surface 12a of the main body 10.

The fixing cover 500 may be maintained at a fixed position with respect to the main body 10. For example, the fixing cover 500 may be screwed to the outer case 12. For example, the fixing cover 500 may be coupled to the guide cover 400.

Details about a configuration of the fixing cover 500 will be described below.

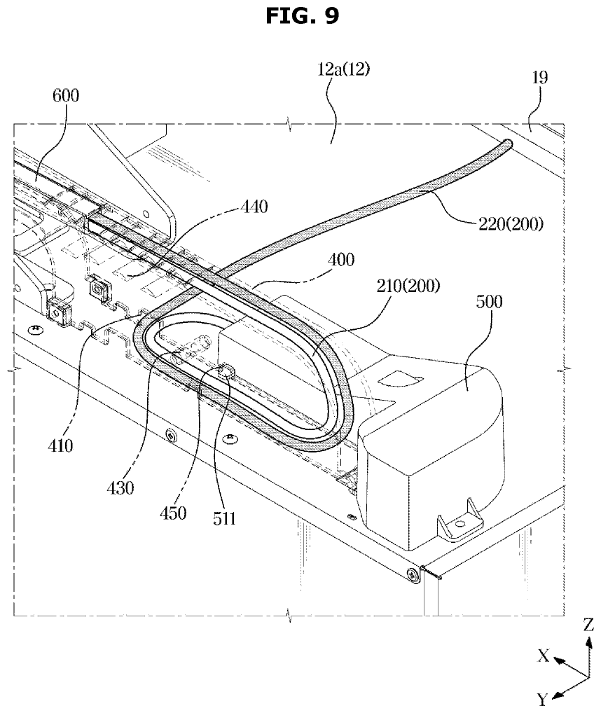

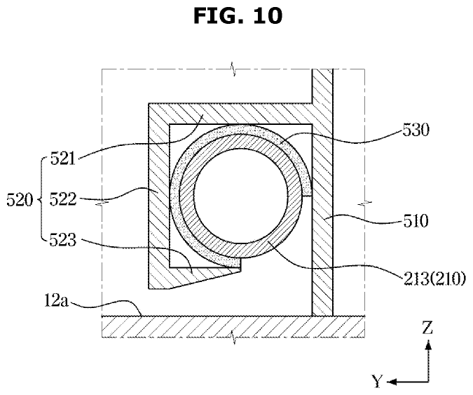

FIG. 8 shows a state in which a supply line of a refrigerator according to an embodiment of the disclosure is positioned. FIG. 9 shows a state in which a supply line of a refrigerator according to an embodiment of the disclosure is positioned. FIG. 10 is an enlarged view of a structure of a line fixing member for fixing a water supply hose in a refrigerator according to an embodiment of the disclosure.

Referring to FIGS. 8 to 10, a portion of the water supply hose 210 of the supply line 200 may be movable with respect to the guide cover 400, and another portion of the water supply hose 210 may be fixed to the fixing cover 500. The other portion of the water supply hose 210, fixed by the fixing cover 500, may be a portion positioned between the accommodation space 401 of the guide cover 400 and the outer surface of the main body 10. In other words, a portion of the water supply hose 210, positioned between the line guide 310 or the main body penetration portion 10a (which will be described below) and the guide cover 400, may be fixed by the fixing cover 500.

The water supply hose 210 may be connected to the main body 10. The main body 10 may include the main body penetration portion 10a formed in the outer surface of the main body 10, and the water supply hose 210 may penetrate the main body penetration portion 10a. A portion of the water supply hose 210 may be positioned inside the water supply assembly connecting guide 310, and another portion of the water supply hose 210 may extend from inside of the water supply assembly connecting guide 310 to the outside of the main body 10 through the main body penetration portion 10a.

The fixing cover 500 may include a cover portion 510 covering a portion of the water supply hose 210. The cover portion 510 may form a space in which a portion of the water supply hose 210 is accommodated.

The cover portion 510 may be provided on the outer surface of the main body 10. More specifically, as shown in FIG. 6, the fixing cover 500 may be provided on the upper surface 12a of the main body 10. The space in which the portion of the water supply hose 210 is accommodated may be defined as a space formed between an inner surface of the cover portion 510 and the outer surface of the main body 10.

The cover portion 510 may be maintained at a fixed position with respect to the main body 10. For example, the cover portion 510 may be screwed to the outer case 12. For example, the cover portion 510 may be coupled to the guide cover 400.

The cover portion 510 may cover the main body penetration portion 10a. A portion of the water supply hose 210 extending from the main body penetration portion 10a to the outside of the main body 10 may be covered by the cover portion 510.

The cover portion 510 may include a fixing cover opening 512. The water supply hose 210 may penetrate the fixing cover opening 512. For example, the fixing cover opening 512 may be formed at a front portion of the cover portion 510 in an X direction.

The fixing cover 500 may include a fixing portion 520 fixing a portion of the water supply hose 210.

The fixing portion 520 may be positioned inside the fixing cover 500. The fixing portion 520 may be provided inside the cover portion 510. The fixing portion 520 may fix the portion of the water supply hose 210, covered by the cover portion 510.

The fixing portion 520 may be supported on an inner wall of the cover portion 510. For example, the fixing portion 520 may be integrated into the cover portion 510, although not limited thereto.

The fixing portion 520 may surround at least one portion of the outer surface of the water supply hose 210 to fix the portion of the water supply hose 210.

More specifically, the water supply hose 210 may include a first hose portion 211, a second hose portion 212 separated from the first hose portion 211, and a connector 213 connecting the first hose portion 211 to the second hose portion 212.

For example, the first hose portion 211 may be connected to the main body 10, and the second hose portion 212 may be connected to the door 30. The first hose portion 211 and the second hose portion 212 may communicate with each other through the connector 213.

By configuring the water supply hose 210 by connecting the first hose portion 211 to the second hose portion 212 through the connector 213, instead of using a single long hose, convenience in performing a manufacturing process of positioning the water supply hose 210 may be improved, a manufacturing time may be shortened, and manufacturing cost may be reduced. Also, it may be easy to wash or replace the water supply hose 210. Also, it may be possible to appropriately change a flow rate or hydraulic pressure in the first hose portion 211 and the second hose portion 212 according to a purpose by using the connector 213.

Each of the first hose portion 211 and the second hose portion 212 may be a flexible hose. For example, the first hose portion 211 and the second hose portion 212 may include a soft polymer material.

The connector 213 may include a hard material. For example, the connector 213 may include a hard plastic material.

While water is supplied to the water supply assembly 80 through the water supply hose 210, vibrations may be generated in the water supply hose 210 by hydraulic pressure. In this case, in a case in which the water supply hose 210 is not sufficiently fixed, the vibrations may cause repeated collisions between the water supply hose 210 and the outer surface of the main body 10, resulting in generation of noise. This may be particularly more problematic in a case in which the connector 213 is made of a hard material.

To overcome the problem, the fixing portion 520 may fix the connector 213 as a portion of the water supply hose 210. More specifically, the fixing portion 520 may surround at least one portion of an outer surface of the connector 213 to fix the connector 213.

For example, as shown in FIG. 10, the fixing portion 520 may include a support portion 521, a first extension portion 522, and a second extension portion 523.

The support portion 521 may protrude from the inner wall of the cover portion 510 and be supported on the inner wall of the cover portion 510. The first extension portion 522 may extend from one end of the support portion 521, the end being opposite to the inner wall of the cover portion 510. The first extension portion 522 may face the inner wall of the cover portion 510. A surface of the first extension portion may face the inner wall of the cover portion 510 as is shown in at least FIG. 10. The second extension portion 523 may extend from one end of the first extension portion 522, the end being opposite to another end at which the first extension portion 522 extends to the support portion 521. The second extension portion 523 may face the support portion 521. A surface of the second extension portion 523 may face the support portion 521 as is shown in at least FIG. 10.

At least one portion of the outer surface of the connector 213, as a portion of the water supply hose 210, may be covered by each of the support portion 521, the first extension portion 522, and the second extension portion 523.

For example, the support portion 521 may cover the connector 213 from above in a Z direction, the first extension portion 522 may cover the connector 213 in a horizontal direction that is parallel to an X-Y plane, and the second extension portion 523 may cover the connector 213 from below in the Z direction. The inner wall of the cover portion 510, from which the support portion 521 protrudes, may also cover the connector 213 in the horizontal direction that is parallel to the X-Y plane, at a position being opposite to the first extension portion 522.

By this configuration, the water supply hose 210 may be hook-coupled to the fixing portion 520 and fixed to the fixing cover 500. The above descriptions about the portions of the fixing portion 520 may be examples of portions constituting the fixing portion 520 to fix the water supply hose 210, and a concept of the disclosure is not limited thereto.

The fixing portion 520 may space the connector 213 from the outer case 12 and fix the connector 213 to the outer case 12. That is, because the connector 213 is fixed to the fixing portion 520, the connector 213 may be spaced a preset distance from the upper surface 12a of the main body 10. By this configuration, the connector 213 may be efficiently prevented from colliding with the upper surface 12a of the main body 10.

The fixing cover 500 may further include a buffer member 530. The buffer member 530 may include various kinds of elastic materials.

The buffer member 530 may be positioned between at least one portion of the outer surface of the water supply hose 210 and the fixing portion 520. More specifically, the buffer portion 530 may be positioned between at least one portion of the outer surface of the connector 213 and the fixing portion 520. The buffer portion 530 may be positioned along an inner surface of the fixing portion 520, covering the outer surface of the connector 213.

The buffer member 530 may more efficiently reduce noise generated by vibrations of the water supply hose 210 while water is supplied to the water supply assembly 80 through the water supply hose 210.

However, the fixing cover 500 may directly fix a soft hose portion (for example, the first hose portion 211 or the second hose portion 212) of the water supply hose 210, instead of the connector 213. The soft hose portion of the water supply hose 210 may be fixed by the fixing portion 520. The buffer member 530 may be positioned between the soft hose portion of the water supply hose 210 and the fixing portion 520.

The wire 220 of the supply line 200 may be connected to the electrical box 19 of the main body 10.

As shown in FIG. 8, in a case in which the electrical box 19 is provided on the outer surface of the outer case 12, the wire 220 may be connected to the controller by penetrating the electrical box 19 outside the outer case 12. However, unlike this, in a case in which the electrical box accommodating the electrical components constituting the controller is provided inside the outer case 12, the wire 220 may be connected to the controller by sequentially penetrating the outer case 12 and the electrical box 19.

FIGS. 8 to 10 relate to an embodiment in which only the water supply hose 210 of the supply line 200 is fixed by the fixing cover 500 and only the water supply hose 210 is covered by the fixing cover 500. However, the disclosure is not limited to the embodiment.

Unlike FIGS. 8 to 10, the wire 220 may also be covered by the fixing cover 500. Furthermore, the wire 220 may also be fixed by the fixing portion 520 of the fixing cover 500. In this case, configurations of the fixing cover 500 and the fixing portion 520 fixing the wire 220 may be the substantially same as those of the fixing cover 500 and the fixing portion 520 fixing the water supply hose 210 of FIGS. 8 to 10.

The guide cover 400 may include a first penetration opening 410 and a second penetration opening 420 which the supply line 200 penetrates. The supply line 200 may penetrate the accommodating space 401 through the first penetration opening 410 and the second penetration opening 420.

Upon opening or closing of the door 30, a portion of the supply line 200 may be drawn into or from the accommodating space 401 through the second penetration opening 420.

The moving member 600 may penetrate the second penetration opening 420. Upon opening or closing of the door 30, the moving member 600 may be drawn into or from the accommodating space 401 through the second penetration opening 420.

The guide cover 400 may include a movement guide portion 440 for guiding the moving member 600 and a portion of the supply line 200 to move with respect to the accommodating space 401. The movement guide portion 440 may be provided inside the accommodating space 401. The movement guide portion 440 may support the moving member 600 and the portion of the supply line 200 from below.

For example, the supply line 200 may be fixed to the guide cover 400 at the first penetration opening 410. More specifically, at the first penetration opening 410, a fitting member (not shown) may be provided to fill a gap formed between the portion of the supply line 200 penetrating the first penetration opening 410 and an edge of the first penetrating opening 410. For example, the fitting member may include an elastic member such as rubber.

In this case, a portion of the supply line 200, which is movable with respect to the accommodating space 401, may be a portion extending from the first penetration opening 410 to the door 30 via the second penetration opening 420, although not limited thereto.

However, the supply line 200 may be not fixed to the guide cover 400 at the first penetration opening 410.

The water supply hose 210 and the wire 220 of the supply line 200 may be positioned at a substantially same position inside the guide cover 400. The water supply hose 210 and the wire 220 may move by a substantially same distance with respect to the accommodating space 401 according to a rotation of the door 30.

The supply line 200 may penetrate the moving member 600. The supply line 200 may penetrate one end of the moving member 600 toward the guide cover 400 and another end of the moving member 600 toward the hinge 100. The supply line 200 may move with respect to the accommodating space 401 together with the moving member 600 according to a rotation of the door 30.

The fixing cover 500 may be coupled to the guide cover 400. For example, the fixing cover 500 may include a guide cover coupling portion 511, and the guide cover 400 may include a fixing cover coupling portion 450 to which the guide cover coupling portion 511 is fixed.

For example, as shown in FIG. 8, the guide cover coupling portion 511 may be in a shape of a protrusion, and the fixing cover coupling portion 450 may be in a shape of a hole which the guide cover coupling portion 511 penetrates. The fixing cover coupling portion 450 may be inserted in the guide cover coupling portion 511 by penetrating the guide cover coupling portion 511, although not limited thereto.

However, the guide cover 400 and the fixing cover 500 may be coupled to each other by various methods.

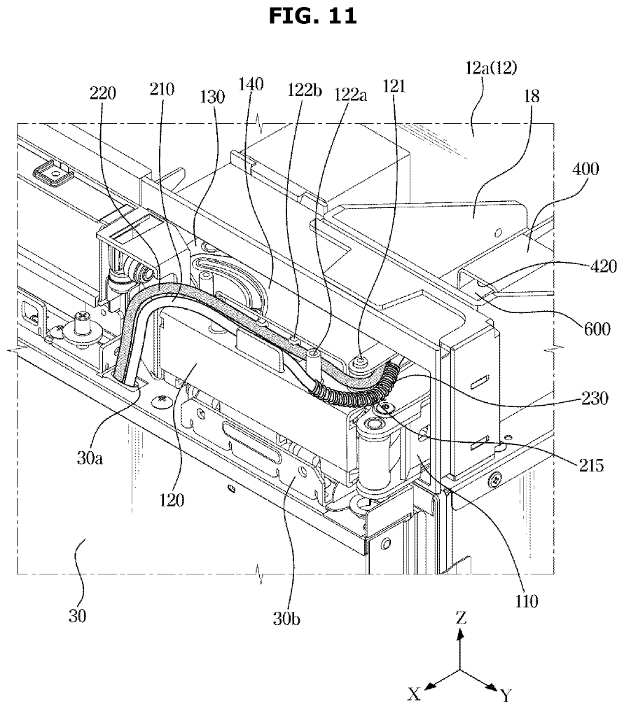

FIG. 11 is an enlarged view of some components, such as a hinge, a supply line, etc., of a refrigerator according to an embodiment of the disclosure.

Referring to FIG. 11, the hinge 100 may include the main body bracket 110 fixed to the main body 10, the door bracket 120 fixed to the door 30, and the hinge link 130 connecting the main body bracket 110 to the door bracket 120.

The main body bracket 110 may be fixed to the main body 10 regardless of a rotation of the door 30. For example, the main body bracket 110 may be fixed to the main body 10 by being coupled to the hinge fixing bracket 18.

The door bracket 120 may be fixed to the door 30 and rotate together with the door 30. The door 30 may include a hinge coupling portion 30b coupled to the door bracket 120. For example, the hinge coupling portion 30b may be screwed to the door bracket 120.

The hinge link 130 may be rotatable with respect to the main body bracket 110 or the door bracket 120.

For example, the hinge link 130 may include a first hinge link, a second hinge link, and a third hinge link.

The first hinge link may be rotatable with respect to the main body bracket 110.

The second hinge link may connect the first hinge link to the door bracket 120, and be rotatable with respect to each of the first hinge link and the door bracket 120.

The third hinge link may connect the first hinge link to the door bracket 120, and be rotatable with respect to each of the first hinge link and the door bracket 120.

A rotation axis of the second hinge link with respect to the first hinge link may be different from a rotation axis of the third hinge link with respect to the first hinge link. Likewise, a rotation axis of the second hinge link with respect to the door bracket 120 may be different from a rotation axis of the third hinge link with respect to the door bracket 120.

The hinge 100 may further include a link guide 140 for guiding a movement path of the hinge link 130.

Referring to FIGS. 12 to 14, while the door 30 rotates to open the storage room 21, the door bracket 120 may rotate in a counterclockwise direction in FIGS. 12 to 14. Also, the first hinge link of the hinge link 130, connected to the main body bracket 110, may rotate in the counterclockwise direction with respect to the main body bracket 110 in FIGS. 12 to 14, and each of the second and third hinge links connected to the door bracket 120 may rotate in a clockwise direction with respect to the first hinge link.

By the operation, while the door 30 rotates to open the storage room 12, the door 30 may rotate while moving away from the main body 10 in the front direction as the X direction.

Referring to FIGS. 12 to 14, while the door 30 rotates to close the storage room 21, the door bracket 120 may rotate in the clockwise direction in FIGS. 12 to 14. Also, the first hinge link of the hinge link 130, connected to the main body bracket 110, may rotate in the clockwise direction with respect to the main body bracket 110 in FIGS. 12 to 14, and each of the second and third hinge links connected to the door bracket 120 may rotate in the counterclockwise direction with respect to the first hinge link.

By the operation, while the door 30 rotates to close the storage room 21, the door 30 may rotate while moving close to the main body 10.

However, the above-described configuration of the hinge 100 may be an example of a hinge connecting a door of a refrigerator according to an embodiment of the disclosure to a main body, and a concept of the disclosure is not limited thereto.

The moving member 600 may be coupled to the hinge 100. More specifically, the moving member 600 may be coupled to the door bracket 120.

The moving member 600 may be coupled to a moving member coupling portion 121 provided in the door bracket 120. For example, the moving member coupling portion 121 may be in a shape of a protrusion protruding upward, and penetrate a hole formed in one end of the moving member 600 to couple the moving member 600 to the moving member coupling portion 121. One end of the moving member 600 may be rotatable with respect to the moving member coupling portion 121.

While the door 30 rotates to open the storage room 21, the moving member 600 may move away from the main body 10 together with the door bracket 120. Accordingly, the moving member 600 may move in a direction of being drawn from the accommodating space 401.

In contrast, while the door 30 rotates to close the storage room 21, the moving member 600 may move in a direction of approaching the main body 10 together with the door bracket 120. Accordingly, the moving member 600 may move in a direction of being drawn into the accommodating space 401.

One end of the moving member 600, coupled to the hinge 100, may support a portion of the supply line 200. More specifically, while the door 30 is at the closed position, a portion of the supply line 200, located adjacent to the door bracket 110, may be bent, and the one end of the moving member 600, coupled to the hinge 100, may support a bent portion of the supply line 200. Also, the one end of the moving member, coupled to the hinge 100, may guide the portion of the supply line 200 to be bent.

The portion of the supply line 200 may surround a portion of a circumference of the one end of the moving member 600, coupled to the hinge 100.

For example, in the water supply hose 210, a hose bending portion 215 which will be described below may be supported by the one end of the moving member 600, coupled to the hinge 100, and guided to be bent.

The door bracket 120 may include guide portions 122a and 122b for guiding the supply line 200. The guide portions 122a and 122b may guide a position of each of the water supply hose 210 and the wire 220 on the door bracket 120. The guide portions 122a and 122b may support the water supply hose 210 and the wire 220, respectively.

For example, as shown in FIG. 11, the wire 220 extending from one end of the moving member 600 toward a door penetration portion 30a may pass a rear portion of the first guide portion 122a while the door 30 is at the closed position. Also, the water supply hose 210 extending from one end of the moving member 600 toward the door penetration portion 30a may pass a front portion of the first guide portion 122a while the door 30 is at the closed position. As such, the first guide portion 122a may separate the water supply hose 210 from the wire 220 around the bent portion of the supply line 200, thereby preventing a tangle of the water supply hose 210 and the wire 220.

The second guide portion 122b may be positioned between the first guide portion 122a and the door penetration portion 30a. The second guide portion 122b may guide the water supply hose 210 and the wire 220 to be arranged side by side toward the door penetration portion 30a.

Positions of the water supply hose 210 and the wire 220 may be appropriately set according to design factors, such as connection positions and connection relations with respect to the water supply 81, etc. inside the door 30, and may be not limited to the positions shown in FIG. 11.

The water supply hose 210 may include an elastic spring 230 for providing an elastic force to the bent portion upon a rotation of the door 30 to prevent the water supply hose 210 from being damaged.

More specifically, the water supply hose 210 may include a hose bending portion 215 that is positioned adjacent to the hinge 100 and bent upon closing of the storage room 21 by the door 30. The hose bending portion 215 may be positioned adjacent to one end of the moving member 600, coupled to the hinge 100.

The elastic spring 230 may surround an outer circumferential surface of the hose bending portion 215. The elastic spring 230 may provide an elastic force to the hose bending portion 215. The elastic spring 230 may be bent together with the hose bending portion 215 according to opening or closing of the door 30.

However, the water supply hose 210 may include various components for preventing the hose bending portion 215 from being damaged. For example, the water supply hose 210 may include a cover (not shown) including various elastic materials such as rubber, and protect the hose bending portion 215 through the cover.

As shown in FIG. 11, the elastic spring 230 may be provided in the water supply hose 210 and may be not provided in the wire 220. The reason may be because the wire 220 generally having a thick insulating coating is not easily damaged and, in a case in which the wire 220 includes a corresponding elastic spring, the elastic spring may get tangled with the elastic spring 230 of the water supply hose 210.

However, a component corresponding to the elastic spring 230 for protecting the hose bending portion 215 of the water supply hose 210 may be provided in the bent portion of the wire 220.

The door 30 may include the door penetration portion 30a which the supply line 200 penetrates. The door penetration portion 30a may communicate the inside of the door 30 with the outside. The supply line 200 may penetrate the door penetration portion 30a and be connected to various components provided in the door 30, such as the water supply assembly 80, etc.

FIG. 11 relates to an embodiment in which both the water supply hose 210 and the wire 220 penetrate a single door penetration portion 30a. However, the water supply hose 210 and the wire 220 may respectively penetrate different door penetration portions.

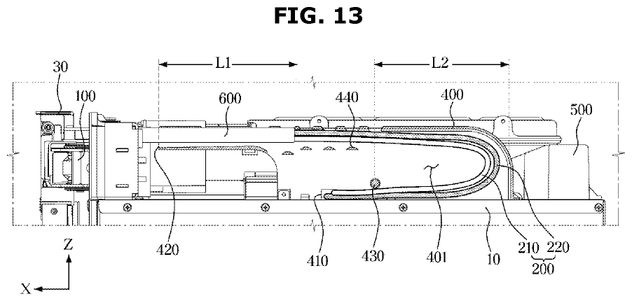

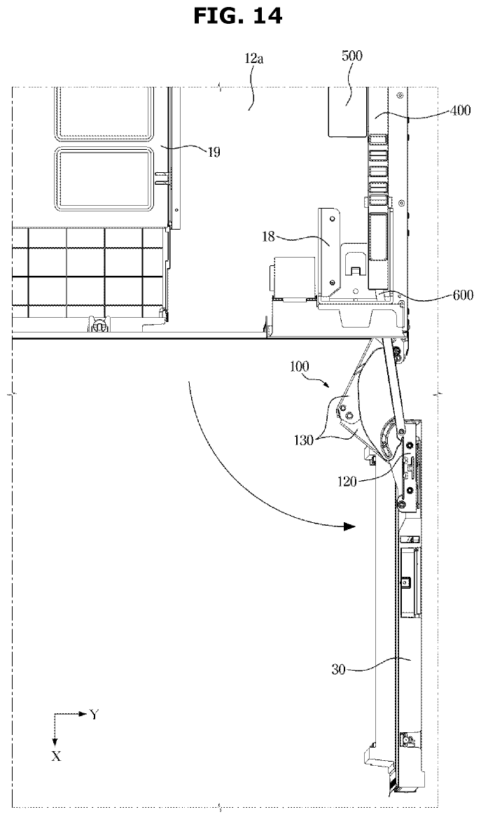

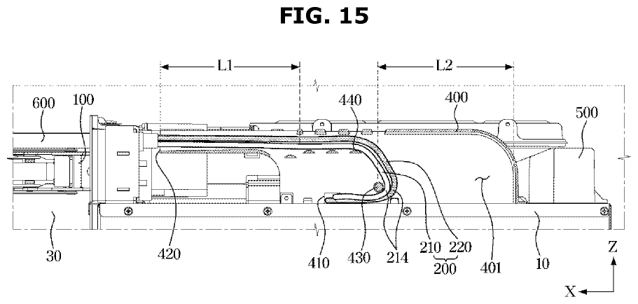

FIG. 12 shows a state in which a door is closed in a refrigerator according to an embodiment of the disclosure. FIG. 13 shows a state of a supply line in a line cover while a door is closed in a refrigerator according to an embodiment of the disclosure. FIG. 14 shows a state in which a door opens in a refrigerator according to an embodiment of the disclosure. FIG. 15 shows a state of a supply line in a line cover while a door opens in a refrigerator according to an embodiment of the disclosure.

Referring to FIGS. 12 to 13, while the door 30 is at a position of closing the storage room 21, the supply line 200 may be at a position where a portion is maximally drawn into the accommodating space 401 of the guide cover 400. Referring to FIGS. 14 and 15, while the door 30 is at a position of opening the storage room 22, the supply line 200 may be at a position where a portion is maximally drawn in the front direction from the accommodating space 401 of the guide cover 400.

Likewise, as shown in FIGS. 12 and 13, while the door 30 is at the position of closing the storage room 21, the moving member 600 may be at a position where at least one portion is maximally drawn into the accommodating space 401 of the guide cover 400. Also, as shown in FIGS. 14 and 15, while the door 30 is at the position of opening the storage room 22, the moving member 600 may be at a position where at least one portion is maximally drawn from the accommodating space 401 of the guide cover 400.

The guide cover 400 may include a line support portion 430 supporting a portion of the supply line 200 while a portion of the supply line 200 accommodated in the accommodating space 401 moves in the front direction with respect to the accommodating space 401.

More specifically, the supply line 200 may include a line bending portion 214 positioned inside the guide cover 400 and bent. The line bending portion 214 may be provided in each of the water supply hose 210 and the wire 220.

The line support portion 430 may support the line bending portion 214 while the door 30 opens the storage room 21 and a portion of the supply line 200 moves with respect to the guide cover 400.

The line support portion 430 may be positioned behind the first penetration opening 410. As shown in FIGS. 13 and 15, a portion of the supply line 200 accommodated in the accommodating space 401 may include a portion extending from the first penetration opening 410 to behind the support portion 430, and another portion bent from the one portion and extending in the front direction.

While the door 30 opens the storage room 21 and a portion of the supply line 200 moves with respect to the guide cover 400, the line bending portion 214 may be supported by the line support portion 430 behind the line support portion 430.

The line bending portion 214 may be formed between a left surface and right surface of the guide cover 400, and extend in the left-right direction as the Y direction. For example, the line bending portion 214 may be in a shape of a bar extending substantially in the Y direction.

The line support portion 430 may guide the supply line 200 to move in the accommodating space 401 of the guide cover 400 and prevent the supply line 200 from getting tangled.

The accommodating space 401 of the guide cover 400 may include a preset spare space to prevent the supply line 200 from getting tangled inside the accommodating space 401 while the door 30 is at the position of closing the storage room 21 and the supply line 200 is maximally drawn into the accommodating space 401.

While the door 30 moves between the open position and the closed position, a movement distance L1 of the moving member 600 may be substantially equal to a movement distance of the supply line 200.

At this time, a distance L2 from the line support portion 430 to a rear end of the guide cover 400 may be a distance in front-rear direction of the spare space where a portion of the supply line 200 moves in the rear direction inside the accommodating space 401, that is, the spare space where the supply line 200 is maximally drawn into the accommodating space 401, while the door 30 rotates from the open position to the closed position.

Accordingly, the distance L2 from the line support portion 430 to the rear end of the guide cover 400 may be longer than or at least equal to the distance L1 by which the moving member 600 is movable according to opening or closing of the door 30.

FIGS. 13 and 15 show an embodiment in which the water supply hose 210 and the wire 220 are separated from each other and movable inside the guide cover 400 and the moving member 600. Unlike this, the water supply hose 210 and the wire 220 may be surrounded by a cover (not shown) inside the guide cover 400 and the moving member 600 and movable together, or the water supply hose 210 and the wire 220 may be loosely surrounded by a soft cover (not shown) and a lubricant may be applied on an inner side of the soft cover. By this configuration, while the hose 210 and the wire 220 move inside the guide cover 400 and the moving member 600, mutual friction may be reduced.

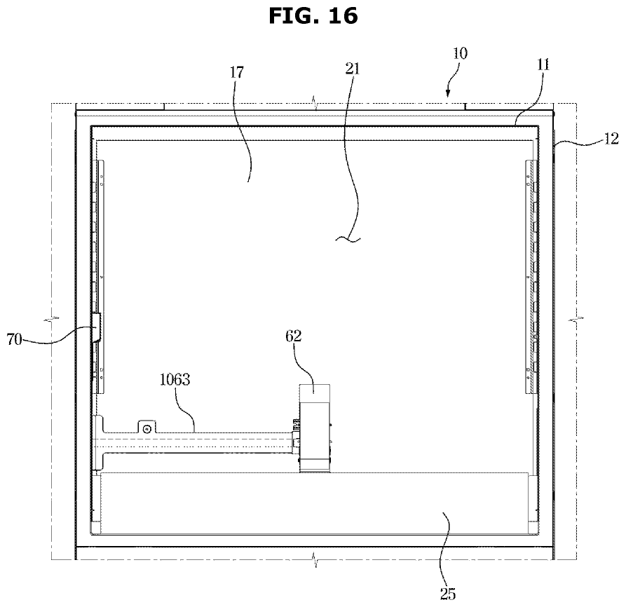

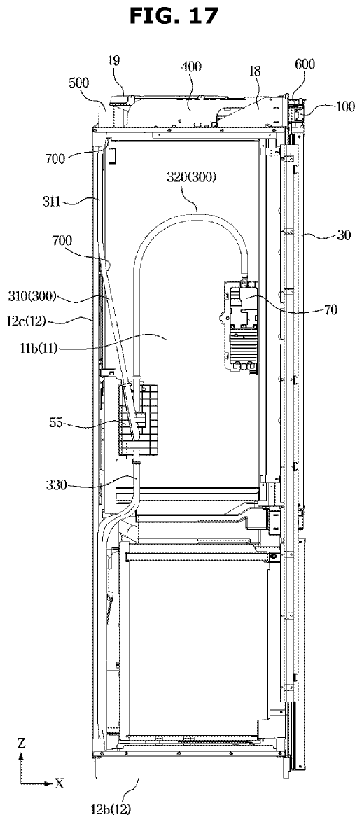

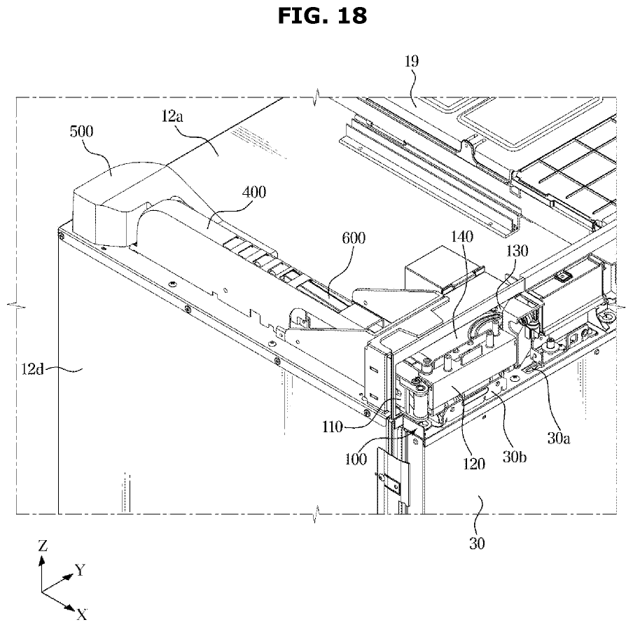

FIG. 16 is a front view separately showing some components of a refrigerator according to an embodiment of the disclosure. FIG. 17 is a side view separately showing some components of a refrigerator according to an embodiment of the disclosure. FIG. 18 is an enlarged view of some components of a refrigerator according to an embodiment of the disclosure.

In the following descriptions about an embodiment of the disclosure with reference to FIGS. 16 to 18, the same components as those described above with reference to FIGS. 1 to 15 are assigned like reference numerals, and descriptions thereof will be omitted.

Referring to FIGS. 16 to 18, the dispenser 70 may be provided on the left inner wall of the inner case 11, unlike FIGS. 1 to 15.

Also, the water supply assembly 80 may be provided in the left upper door 31 (see FIG. 1).

As shown in FIG. 16, the refrigerator 1 may include a water supply duct 1063 provided in the storage room 21 and connected to the water tank 62. For example, the water supply duct 1063 may be provided at the rear portion of the inner case 11. The water supply duct 1063 may be provided in front of the cool air supply duct 17.

Inside the water supply duct 1063, both a flow path through which water is supplied to the water tank 62 and a flow path through which water is supplied from the water tank 62 may be formed.

A flow path 52 (see FIG. 2) extending from the water filter 61 to the water tank 62 and flow paths 53 and 54 (see FIG. 2) extending from the water tank 62 to the dispenser 70 or the water supply assembly 80 may pass through the water supply duct 1063.

As shown in FIG. 17, the line guide 300 of the refrigerator 1 may be provided at a left portion of the main body 10. More specifically, the water supply assembly connecting guide 310 may extend from the flow path diverging portion 55 provided at the left portion of the inner case 11, and the dispenser connecting guide 320 may extend from the flow path diverging portion 55 provided at the left portion of the inner case 11.

The refrigerator 1 may further include a water tank connecting guide 330 along which the flow path 52 (see FIG. 2) extending from the water filter 61 toward the water tank 62 passes. Inside the water tank connecting guide 330, a portion of the flow path 52 for supplying water purified by the water filter 61 to the water tank 62 may be formed. More specifically, the water tank connecting guide 330 may be provided at the left portion of the main body 10, and extend from the water filter 61 to the flow path diverging portion 55 provided at the left portion of the inner case 11.

Each of the water supply assembly connecting guide 3310, the dispenser connecting guide 320, and the water tank connecting guide 330 may communicate with a water supply duct 1036 at the flow path diverging portion 55.

The water supply assembly connecting guide 310 may be positioned between the left portion of the inner case 11 and the left portion of the outer case 12 and be connected to a left portion of the upper surface 12a of the main body 10.

As shown in FIG. 18, the guide cover 400, the fixing cover 500, the moving member 600, etc. may be provided at the left portion of the upper surface 12a of the main body 10.

Components of the refrigerator 1, such as the hinge 100, the line guide 300, the guide cover 400, the fixing cover 500, the moving member 600, the spacer 700, etc., as shown in FIGS. 16 to 18, may have characteristics corresponding to the components of the refrigerator 1, as shown in FIGS. 1 to 15, and detailed descriptions thereof will be omitted.

In the embodiment described above with reference to FIGS. 1 to 15 and the embodiment described above with reference to FIGS. 16 to 18, design factors, such as shapes, arrangements, etc., of components may vary according to whether the dispenser 70 and the water supply assembly 80 are provided on the left or right side of the refrigerator.

To improve convenience of mold making of each component and reduce waste of components, the line guide 300, such as the water supply assembly connecting guide 310, the dispenser connecting guide 320, etc., may have the same shape and be arranged at the same position regardless of whether the line guide 300 is connected to the left or right portion of the main body 10.

Also, to improve convenience of mold making and reduce waste of components, the guide cover 400 may have bilateral symmetry on an X axis in the drawings. For example, in the guide cover 400, the first penetration opening 410 may be designed as a pair to have bilateral symmetry on the X axis, and the fixing cover coupling portion 450 may be designed as a pair to have bilateral symmetry on the X axis.

In addition, the moving member 600 and some components (for example, the door bracket 120, etc.) of the hinge 100 may have bilateral symmetry on the X axis in the drawings.

Meanwhile, a concept of the disclosure is not limited to that shown in FIGS. 1 to 18. For example, the dispenser 70 may be provided at the left inner wall of the inner case 11, and the water supply assembly 80 may be provided at the right upper door 32. Alternatively, for example, the dispenser 70 may be provided at the right inner wall of the inner case 11 and the water supply assembly 80 may be provided at the left upper door 31.

In this case, the shapes and arrangements of the water supply assembly connecting guide 310, the dispenser connecting guide 320, the water supply duct, etc. may change appropriately according to an arrangement of the dispenser 70 and the water supply assembly 80.

In addition, the above description relates to a case in which the water filter 61 is provided at the left lower portion of the refrigerator 1. However, a location of the water filter 61 is not limited to this, and shapes and arrangements of the water supply assembly connecting guide 310, the dispenser connecting guide 320, the water supply duct, etc. may change appropriately according to the location of the water filter 61.

A refrigerator 1 according to an embodiment of the disclosure may include: a main body 10 including an outer case 12, and an inner case 11 positioned inside the outer case and forming a storage room; a door 30 configured to open or close the storage room; a hinge 100 supporting the door such that the door is rotatable with respect to the main body; a supply line 200 including a water supply hose 210, wherein one end of the supply line is connected to the main body and another end of the supply line is connected to the door; a guide cover 400 provided on an upper surface of the main body and forming an accommodating space 401 in which a portion of the supply line is movably accommodated; and a fixing cover 500 provided on the upper surface of the main body and fixing another portion of the supply line. According to the disclosure, a position of the supply line 200 may be guided by the guide cover 400 and the fixing cover 500. Also, the guide cover 400 and the fixing cover 500 may prevent the supply line 200 from being damaged by an external impact. Also, upon opening or closing of the storage room 21 by the door 30, the guide cover 400 may guide a movement of the supply line 200. The fixing cover 500 may reduce noise that is generated while water is supplied through the water supply hose 210.

The fixing cover 500 may include: a cover portion 510 coupled to the outer case and covering the other portion of the supply line; and a fixing portion 520 positioned inside the cover portion and surrounding at least one portion of an outer surface of the supply line to fix the another portion of the supply line.

The water supply hose 210 may include a first hose portion 211, a second hose portion 212 separated from the first hose portion 211, and a connector 213 connecting the first hose portion to the second hose portion, and the fixing portion 520 may surround at least one portion of an outer surface of the connector 213 to fix the connector.

The fixing portion 520 may space the connector 213 from the outer case 12 and fix the connector 213 to the outer case 12. According to the disclosure, noise that is generated while water is supplied through the water supply hose 210 may be more efficiently reduced.

The fixing portion 520 may include: a support portion 521 protruding from an inner wall of the cover portion 510 and supported on the inner wall of the cover portion; a first extension portion 522 extending from one end of the support portion, the one end being opposite to the inner wall of the cover portion, the first extension portion facing the inner wall of the cover portion; and a second extension portion 523 extending from one end of the first extension portion 522, the one end of the first extension portion being opposite to the support portion, the second extension portion 523 facing the support portion, wherein at least one portion of an outer surface of the another portion of the supply line may be covered by each of the support portion, the first extension portion, and the second extension portion.

The fixing cover 500 may further include a buffer member 530 including an elastic material. The buffer member 530 may be positioned between at least one portion of an outer surface of the supply line and the fixing portion. According to the disclosure, noise that is generated while water is supplied through the water supply hose 210 may be more efficiently reduced.

The refrigerator 1 may further include: a line guide 310 accommodating at least one portion of the supply line and positioned between the inner case and the outer case; and a spacer 700 provided between at least one portion of the line guide and the inner case to space the at least one portion of the line guide from the inner case. According to the disclosure, the position of the supply line 200 may be guided by the line guide 310. Also, a foaming agent that is injected to foam an insulation between the inner case and the outer case may be uniformly distributed by the spacer 700.

The outer case may include an upper surface, a lower surface, a rear surface and a side surface connecting the upper surface to the lower surface. The main body may further include a corner area 14 formed between the outer case and the inner case and formed between the rear surface and side surface of the outer case. The at least one portion of the guide line 310 may be positioned along the corner area 14.

The spacer 700 may include at least one pair of spacers. The line guide 310 may include a linear portion 311 positioned between the pair of spacers 700 and extending in one direction along the corner area 14 while being in close contact with the outer case 12. According to the disclosure, because the linear portion 311 is in close contact with the outer case 12, a foaming agent that is injected to foam an insulation between the inner case and the outer case may be more uniformly distributed.

The spacer 700 may protrude from the line guide 310 and be in contact with the inner case 11.

The water supply hose 210 may further include a hose bending portion 215 positioned adjacent to the hinge 100 and configured to be bent upon closing of the storage room 21 by the door 30, and an elastic spring 230 surrounding an outer circumferential surface of the hose bending portion 215. According to the disclosure, the elastic spring 230 may efficiently prevent the hose bending portion 215 of the supply line from being damaged.

The supply line 200 may include a line bending portion 214 positioned inside the guide cover 400 and bent. The guide cover 400 may include a line support portion 430 supporting the line bending portion 214 while the door opens the storage room and a portion of the supply line moves with respect to the guide cover. According to the disclosure, the line support portion 430 may guide a movement of the supply line 200 inside the accommodating space 401 of the guide cover 400 and prevent the supply line 200 from getting tangled.

The guide cover 400 may further include a first penetration opening 410 and a second penetration opening 420 which the supply line 200 penetrates, wherein the first penetration opening is adjacent to the fixing cover and the second penetration opening is adjacent to the hinge. The line support portion may be positioned behind the first penetration opening 410. The line bending portion 214 may be supported by the line support portion 430 behind the line support portion 430.

The supply line may further include a wire 220 connected to both the main body and the door. According to the disclosure, the wire 220 may supply power supplied from an external power source to a component provided in the door 30, or transfer an electrical signal that is transmitted/received between the component provided in the door 30 and a controller.

The refrigerator may further include a moving member 600 coupled to the hinge, movably provided in the guide cover, and configured to guide a portion of the supply line to be drawn into or from the accommodating space according to opening or closing of the door. According to the disclosure, the position of the supply line 200 may be guided by the moving member 600. Also, the moving member 600 may prevent the supply line 200 from being damaged by an external impact. Also, a movement of the supply line 200 may be guided by the guide cover 400 upon opening or closing of the storage room 21 by the door 30.

A refrigerator 1 according to an embodiment of the disclosure may include: a main body 10 forming a storage room; a door 30 configured to open or close the storage room; a hinge 100 supporting the door such that the door is rotatable with respect to the main body; a supply line 200 including a water supply hose 210 and a wire 220, wherein one end of the supply line is connected to the main body and another end of the supply line is connected to the door; a guide cover 400 provided on an outer surface of the main body and forming an accommodating space 401 in which a portion of the supply line is movably accommodated according to opening or closing of the door; and a fixing cover 500 provided on the outer surface of the main body and fixing a portion of the water supply hose 210 positioned between the accommodating space 401 and the outer surface of the main body.

The fixing cover 500 may include a fixing portion 520 positioned inside the fixing cover and surrounding at least one portion of an outer surface of the water supply hose to fix the water supply hose 210.

The fixing cover 500 may further include a buffer member 530 including an elastic material. The buffer member 530 may be positioned between the fixing portion 520 and the at least one portion of the outer surface of the water supply hose 210.

The main body may include an outer case 12, an inner case 11 positioned inside the outer case, and an insulation 13 provided between the outer case and the inner case. The refrigerator 1 may further include a line guide 310 accommodating at least one portion of the supply line and positioned between the inner case and the outer case, and a spacer 700 provided between the line guide and the inner case. The at least one portion of the line guide 310 may be positioned along an inner corner of the main body. The spacer 700 may space the at least one portion of the line guide from being spaced from the inner case.

A refrigerator 1 according to an embodiment of the disclosure may include: an outer case 12; an inner case 11 positioned inside the outer case and forming a storage room; an insulation 13 provided between the outer case and the inner case; a door 30 configured to open or close the storage room; a water tank 62 positioned in the inner case; a water supply 81 positioned in the door; a water supply hose 210 connecting the water tank to the water supply; a line guide 300 provided between the inner case and the outer case and accommodating a first portion of a water supply hose positioned between the inner case and the outer case; a guide cover 400 provided on an outer surface of the outer case and forming an accommodating space in which a second portion of the water supply hose is movably accommodated; and a fixing cover 500 provided on the outer surface of the outer case and fixing a third portion of the water supply hose positioned between the line guide and the guide cover.

According to a concept of the disclosure, the refrigerator may include a supply line to supply water or power to a component of the refrigerator, installed in a door.

According to a concept of the disclosure, the refrigerator may guide a position of the supply line through structures of a line guide, a guide cover, a fixing cover, and a hinge.

According to a concept of the disclosure, the refrigerator may include a guide cover and a moving member to guide a movement of the supply line upon opening or closing of a storage room by the door supported by a multi-joint hinge.

According to a concept of the disclosure, the refrigerator may include components, such as the guide cover, the fixing cover, an elastic spring, etc., to prevent the supply line from being damaged.

According to a concept of the disclosure, the refrigerator may include the fixing cover fixing a water supply hose to reduce noise that is generated while water is supplied through the water supply hose.

According to a concept of the disclosure, the refrigerator may include a spacer spacing at least one portion of the line guide from the inner case to uniformly distribute a foaming agent that is injected to foam an insulation between the inner case and the outer case.

According to a concept of the disclosure, the refrigerator may form various components, such as the line guide, the guide cover, etc., in a bilateral symmetry to improve convenience of mold making and reduce waste of components.

So far, specific embodiments have been shown and described, however, the disclosure is not limited to these embodiments. It should be interpreted that various modifications may be made by one of ordinary skill in the technical art to which the disclosure belongs, without deviating from the gist of the technical concept of the disclosure, which is defined in the following claims.

1. A refrigerator comprising:
a main body forming a storage room;
a door to open and close the storage room;
a hinge supporting the door so that the door is rotatable with respect to the main body between an open position in which the storage room is open and a closed position in which the storage room is closed;
a supply line including a water supply hose, wherein the supply line has one end connected to the main body and another end connected to the door, and a first portion of the supply line is movable when the door is rotated between the open position and the closed position;
a guide cover on an upper surface of the main body and forming an accommodating space in which the first portion of the supply line is movably accommodated; and
a fixing cover on the upper surface of the main body and fixing a second portion of the supply line so that the second portion is maintained in a fixed position when the door is rotated between the open position and the closed position.

2. The refrigerator of claim 1, wherein the fixing cover includes:
a cover portion that covers the second portion of the supply line, and
a fixing portion positioned inside the cover portion and surrounding at least one portion of an outer surface of the second portion of the supply line to maintain the second portion of the supply line in the fixed position.

3. The refrigerator of claim 2, wherein the water supply hose includes:
a first hose portion,
a second hose portion, and a connector connecting the first hose portion to the second hose portion,
wherein the fixing portion surrounds at least one portion of an outer surface of the connector to maintain the connector in the fixed position.

4. The refrigerator of claim 3, wherein the fixing portion spaces the connector from the main body and fixes the connector to the main body.

5. The refrigerator of claim 2, wherein the fixing portion includes:
a support portion protruding from, and supported by, an inner wall of the cover portion;
a first extension portion extending from an end of the support portion opposite to the inner wall of the cover portion, with a surface of the first extension portion facing the inner wall of the cover portion; and
a second extension portion extending from an end of the first extension portion opposite to the support portion, with a surface of the second extension portion facing the support portion,
wherein at least a portion of an outer surface of the second portion of the supply line is covered by each of the support portion, the first extension portion, and the second extension portion.

6. The refrigerator of claim 2, wherein the fixing cover further includes:
a buffer member including an elastic material,
wherein the buffer member is positioned between the at least one portion of the outer surface of the second portion of the supply line and the fixing portion.

7. The refrigerator of claim 1, wherein
the main body includes an outer case, and an inner case positioned inside the outer case and forming the storage room, and
the refrigerator further comprises:
a line guide accommodating a third portion of the supply line and positioned between the inner case and the outer case; and
a spacer provided between at least one portion of the line guide and the inner case to space the at least one portion of the line guide from the inner case.

8. The refrigerator of claim 7, wherein the outer case includes:
a rear surface, and
a side surface,
wherein a corner area is formed between the outer case and the inner case and between the rear surface and side surface of the outer case, and the at least one portion of the line guide is positioned in the corner area.

9. The refrigerator of claim 8, wherein the spacer includes:
at least one pair of spacers, and
the at least one portion of the line guide includes:
a linear portion positioned between the pair of spacers and extending along the corner area while being in close contact with the outer case.

10. The refrigerator of claim 7, wherein the spacer protrudes from the at least one portion of the line guide and is in contact with the inner case.

11. The refrigerator of claim 1, wherein
the water supply hose includes a hose bending portion positioned adjacent to the hinge and configured to be bent when the door is rotated from the open position to the closed position, and
the water supply hose further includes an elastic spring surrounding an outer circumferential surface of the hose bending portion.

12. The refrigerator of claim 1, wherein the supply line includes:
a line bending portion bent inside the accommodating space of the guide cover, and
the guide cover further includes:
a line support portion supporting the line bending portion when the door is rotated to the open position and the first portion of the supply line moves with respect to the guide cover.

13. The refrigerator of claim 12, wherein the guide cover further includes:
a first penetration opening adjacent to the fixing cover and a second penetration opening adjacent to the hinge, wherein the supply line penetrates the first penetration opening and the second penetration opening,
the line support portion is positioned behind the first penetration opening, and
the line bending portion is supported by the line support portion behind the line support portion.

14. The refrigerator of claim 1, wherein
the supply line further includes a wire,
one end of the wire is connected to the main body, and
another end of the wire is connected to the door.

15. The refrigerator of claim 1, further comprising:
a moving member coupled to the hinge,
wherein the moving member is movable with respect to the guide cover, and is configured to guide movement of the first portion of the supply line into and out of the accommodating space when the door is rotated between the open position and the closed position.
